(19) United States
(12) Patent Application Publication
(10) Pub. No.: US 2026/0304279 A1
(43) Pub. Date: Oct. 1, 2026

(54) UE LTM CELL SWITCH COMMAND PREEMPTION MECHANISM

(71) Applicant: QUALCOMM Incorporated, San Diego, CA (US)

(72) Inventors: Doohyun SUNG, Basking Ridge, NJ (US); Jelena DAMNJANOVIC, Del Mar, CA (US); Sitaramanjaneyulu KANAMARLAPUDI, San Diego, CA (US); Tao LUO, San Diego, CA (US)

(21) Appl. No.: 19/090,066

(22) Filed: Mar. 25, 2025

(51) Int. Cl. H04W 36/36; H04B 7/06; H04W 24/02; H04W 36/32

(52) U.S. Cl. CPC H04W 36/362; H04B 7/06952; H04W 24/02; H04W 36/324

(57) ABSTRACT

The apparatus may be a wireless device configured to receive, from a first cell, a cell switch command associated with a first cell switch operation and override the cell switch command based on a cell switch preemption capability of the UE. The apparatus may be a network device, such as a base station, that may be configured to transmit, to a UE, a cell switch command associated with a first cell switch operation and receive, from the UE, an indication of an override of the cell switch command based on a cell switch preemption capability of the UE. The apparatus may be a wireless device, such as a UE, that may be configured to obtain mobility-related information and transmit, to a first cell and based on the mobility-related information, one or more of assistance information or a mobility-related request.

### TECHNICAL FIELD

The present disclosure relates generally to communication systems, and more particularly, to a mobility, cell switch, and/or handover operation and associated signaling.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device, such as a user equipment (UE), that may be configured to receive, from a first cell, a cell switch command associated with a first cell switch operation and override the cell switch command based on a cell switch preemption capability of the UE.

In an aspect of the disclosure, a method, a computer-readable medium, and an apparatus are provided. The apparatus may be a network device, such as a base station, that may be configured to transmit, to a UE, a cell switch command associated with a first cell switch operation and receive, from the UE, an indication of an override of the cell switch command based on a cell switch preemption capability of the UE.

In an aspect of the disclosure, a method, a computer-readable medium, and an apparatus are provided. The apparatus may be a wireless device, such as a UE, that may be configured to obtain mobility-related information and transmit, to a first cell and based on the mobility-related information, one or more of assistance information or a mobility-related request.

In an aspect of the disclosure, a method, a computer-readable medium, and an apparatus are provided. The apparatus may be a network device, such as a base station, that may be configured to receive, from the UE, one or more of assistance information or a mobility-related request and transmit, or omit a transmission of, an additional indication of a response to one or more of the assistance information or the mobility-related request.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram illustrating a method of wireless communication in accordance with some aspects of the disclosure.

FIG. 5 is a call flow diagram illustrating a method of wireless communication in accordance with some aspects of the disclosure.

FIG. 6 is a flowchart of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an apparatus.

FIG. 15 is a diagram illustrating an example of a hardware implementation for a network entity.

### DETAILED DESCRIPTION

In some aspects of wireless communication handover operations may be initiated based on changing conditions at a UE. A network driven approach to handovers, in some aspects, may include a source base station initiating a handover by sending a handover command including a target cell configuration, where a UE receiving the handover command may access the target cell after the target cell configuration is applied. A handover, in some aspects, may be considered a layer 3 (L3) operation and may be referred to as an L3 handover (HO). In some aspects, to reduce radio link failure (RLF), a conditional handover (CHO) may be introduced. A CHO operation, in some aspects, may include configuring and/or preparing the UE with multiple candidate target cells and one or more conditions for performing the CHO in advance enabling a handover command to be sent to the UE early (when the radio conditions are still good). The CHO may then be executed when the configured CHO execution condition(s) are met. In some aspects, to provide seamless service and/or to reduce handover latency even in dense deployments, lower-layer triggered mobility (LTM) (also referred to as layer 1 (L1)/layer 2 (L2) triggered mobility) may be implemented. For LTM, a base station may configure and/or prepare a UE with one or more candidate cells for a cell switch (or handover) by radio resource control (RRC) signaling. A serving cell switch (e.g., the LTM operation corresponding to a L3 handover) may be executed by the base station and UE through L2 signaling and based on L1 measurements and reporting. In some aspects, a base station may configure the UE for conditional LTM (C-LTM).

Various aspects relate generally to LTM enhancements. The LTM enhancements, in some aspects, may include, or relate to, one or more of a UE assisted LTM enhancement scheme which includes a UE providing an assistance information message and/or a request message, an action by a base station in response to the UE's assistance information message and/or the request message, and/or a UE's autonomous action and report (e.g., which may depend on a base station's response to the assistance information message and/or the request message transmitted by a UE). In some aspects, the LTM enhancements may include, or relate to, allowing the UE to ignore a cell switch command (CSC) from the network and override the CSC or perform a different cell switch operation (e.g., a CHO or C-LTM). Allowing the UE to ignore a CSC may be associated with autonomous UE operation during an LTM cell switching procedure for overriding (e.g., preempting or modifying) the LTM behavior upon receiving the LTM CSC based on UE local information. In some examples, a wireless device may be configured to receive, from a first cell, a cell switch command associated with a first cell switch operation and override the cell switch command based on a cell switch preemption capability of the UE. In some examples, a network device may be configured to transmit, to a UE, a cell switch command associated with a first cell switch operation and receive, from the UE, an indication of an override of the cell switch command based on a cell switch preemption capability of the UE. In some examples, a wireless device may be configured to obtain mobility-related information and transmit, to a first cell and based on the mobility-related information, one or more of assistance information or a mobility-related request. In some examples, a network device may be configured to receive, from the UE, one or more of assistance information or a mobility-related request and transmit, or omit a transmission of, an additional indication of a response to one or more of the assistance information or the mobility-related request.

Particular aspects of the subject matter described in this disclosure can be implemented to realize one or more of the following potential advantages. In some examples, by the LTM enhancements related to allowing preemption of a CSC and/or providing an assistance information message and/or a request message, the described techniques can be used to improve mobility operations.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

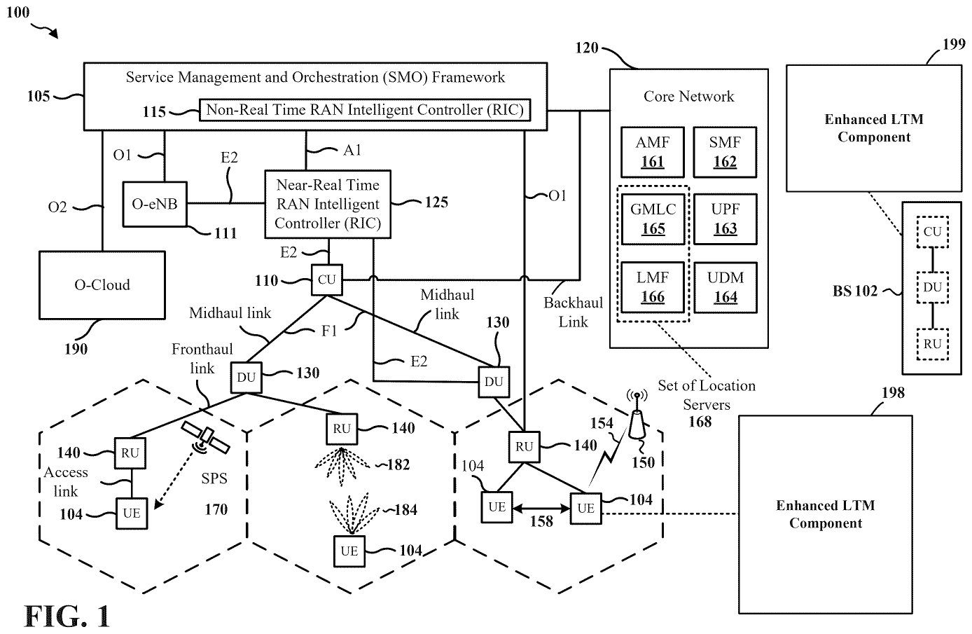

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an enhanced LTM component 198 that may be configured to receive, from a first cell, a cell switch command associated with a first cell switch operation and override the cell switch command based on a cell switch preemption capability of the UE. In some aspects, the enhanced LTM component 198 may be configured to obtain mobility-related information and transmit, to a first cell and based on the mobility-related information, one or more of assistance information or a mobility-related request. In certain aspects, the base station 102 may have an enhanced LTM component 199 that may be configured to transmit, to a UE, a cell switch command associated with a first cell switch operation and receive, from the UE, an indication of an override of the cell switch command based on a cell switch preemption capability of the UE. In some aspects, the enhanced LTM component 199 may be configured to receive, from the UE, one or more of assistance information or a mobility-related request and transmit, or omit a transmission of, an additional indication of a response to one or more of the assistance information or the mobility-related request. Although the following description may be focused on LTM, the concepts described herein may be applicable to other similar areas, such as L3 HO and/or CHO.

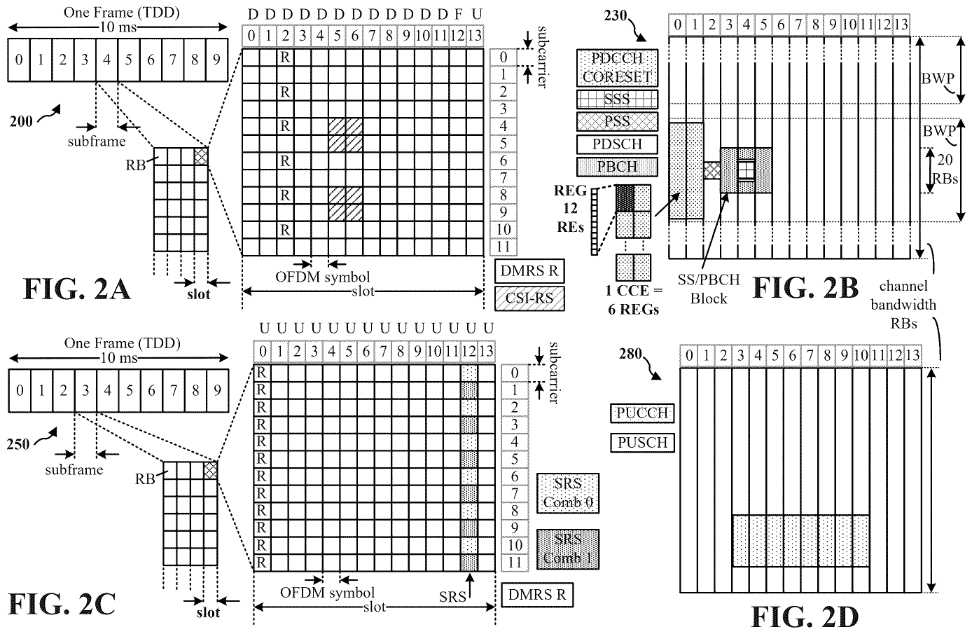

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

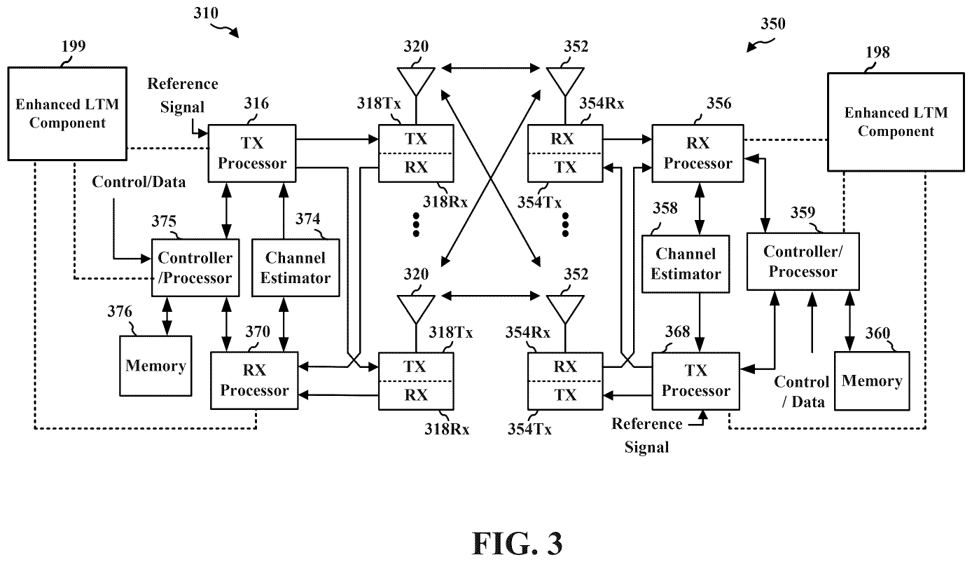

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the enhanced LTM component 198 of FIG. 1.

At least one of the TX processor 316, the RX processor 370, and the controller/processor 375 may be configured to perform aspects in connection with the enhanced LTM component 199 of FIG. 1.

In some aspects of wireless communication handover operations may be initiated based on changing conditions at a UE. A network driven approach to handovers, in some aspects, may include a source base station (e.g., a serving cell or gNB) initiating a handover by sending a handover command including a target cell configuration, where a UE receiving the handover command may access the target cell after the target cell configuration is applied. A handover, in some aspects, may be considered a L3 operation and may be referred to as an L3 handover or L3 HO. In some aspects, to reduce RLF, a CHO may be introduced. A CHO operation, in some aspects, may include configuring and/or preparing the UE with multiple candidate target cells and one or more conditions for performing the CHO in advance enabling a handover command to be sent to the UE early (when the radio conditions are still good). The CHO may then be executed when the configured CHO execution condition(s) are met. In some aspects, to provide seamless service and/or to reduce handover latency even in dense deployments, lower layer triggered mobility (sometimes referred to as L1/L2 triggered mobility or LTM) may be implemented. For LTM, a base station may configure and/or prepare a UE with one or more candidate cells for a cell switch (or handover) by RRC signaling. A serving cell switch (e.g., the LTM operation corresponding to a L3 handover) may be executed by the base station and UE through L2 signaling and based on L1 measurements and reporting. In some aspects, a base station may configure the UE for C-LTM.

For example, upon receiving an LTM cell switch command MAC CE, a UE MAC may (1) indicate to an upper layer that the LTM cell switch procedure is triggered, (2) consider, after performing a MAC reset requested by the upper layer, a random access channel (RACH)-less LTM in the case that a timing advance (TA) command value is not a value indicating RACH (e.g., not “FFF”) or in the case that the UE has successfully measured a TA for the LTM target cell (e.g., for a special cell (SpCell) of the LTM target cell). For example, a UE is configured to follow an indicated transmission configuration indicator (TCI) state identifier (ID) and SSB included in a LTM CSC and perform a RACH-less LTM operation if a valid TA is provided. The RACH-less LTM operation, in some aspects, may be considered to be successful if the downlink assignment is received on PDCCH with cell radio network temporary identifier (C-RNTI) or if the uplink grant received for a new transmission is associated with the same HARQ process for a first PUSCH transmission (CG PUSCH).

As described above, an LTM cell switch (like traditional L3 HO) may be a network-controlled mobility scheme where a base station configures the L1 or L3 measurement reports, and then the LTM cell switch is triggered by an LTM CSC MAC CE. This approach, in some aspects, may be associated with issues relating to (1) network-side information about a UE's situation being limited (i.e., a base station may rely on L1 or L3 measurement reports (CQI, reference signal received power (RSRP), etc.)), and (2) UEs configured to follow a CSC even when the UE may be aware of a bad channel quality associated with the target cell identified in the CSC (i.e., following a wrong HO decision). These issues, in some aspects, may result in HO failure or RLF followed by RRC reestablishment which may be associated with a significant service interruption time. Additionally, issues may arise with one or more of early and/or late cell switch, RLF after cell switch, and ping-pong cell switches (e.g., receiving multiple cell switch commands between target cells each having bad channel quality).

In some aspects, enhancements to LTM may be directed to removing limitations of some implementations of LTM (compared to L3 HO) such as (1) mobility between cells under the same gNB (intra-gNB or intra-CU LTM supported), (2) measurements available with SSBs, and (3) lack of conditional mobility procedure (i.e., LTM CSC MAC-CE based execution). For example, to address support for conditional Intra-CU LTM, the following issues may be addressed: (1) specifying UE evaluated conditions for triggering LTM, (2) supporting conditional LTM including subsequent LTM, (3) limiting specifying the conditional LTM to the scenario where the UE is not in dual connectivity (DC) (e.g., is in non-DC) (4) whether Intra-CU conditional LTM can be specified to DC scenarios and if so, to which cases. In some aspects, the conditional LTM may operate in a similar manner as L3 conditional HO, where UE autonomously switches from the source cell to the target cell when a switch condition is met. Additionally, in some aspects, AI/ML based RRM measurement and event prediction such as HO failure, RLF or measurement events, may be used to enhance the mobility performance (e.g., reduce one or more of link failures after HO, ping-ponging, early/late HO, etc.). The AI/ML based RRM measurement and event prediction may be associated with (1) cell-level measurement prediction including intra-frequency and inter-frequency (UE sided and network sided model), (2) inter-cell beam-level measurement prediction for L3 Mobility (UE sided and network sided model), (3) HO failure/RLF prediction (UE sided model), (4) measurement events prediction (UE sided model). In some aspects, for network side models, the UE may provide additional information (e.g., beyond what is currently reported) to enhance the network side model(s). The evaluation of the AI/ML aided mobility benefits, in some aspects, may be based on HO performance key performance indicators (KPIs) (e.g., ping-pong HO, HOF/RLF, time of stay, handover interruption, prediction accuracy, and measurement reduction, etc.) and complexity trade-offs.

The network-initiated/driven HO procedure purely based on UE's measurement reports has been the primary methodology used for mobility, but as the network deployment becomes more complicated (e.g., heterogeneous cell types, densified deployment), the limitations of network-driven HO procedures are becoming more visible (e.g., in the form of early/late HOs, HO failure (or RLF after HO), ping-pong HOs, etc.). Network-side information, e.g., information available at a base station used to make a HO decision, may be based on reporting from a UE and may not be as complete as the information available at the UE. Accordingly, network-driven HO decisions may be based on incomplete information that leads to the issues identified above (e.g., early/late HOs, HO failure (or RLF after HO), ping-pong HOs, etc.). These issues are often related to non-optimized measurement report configurations and/or UE-side condition change (speed, rotation, direction, etc.). However, triggering more frequent measurement reports may not solve these issues as it may come at the cost of degraded network throughput due to scheduling restrictions and/or measurement gaps.

In some aspects, the UE may have a significant amount of data that may be used to improve network-driven HO decision making. For example, the UE may have AI/ML based prediction information (e.g., based on using convolutional neural networks (CNNs), recurrent neural networks (RNNs), transformers, etc.). The AI/ML based prediction information, in some aspects, may include one or more of measurement prediction, L1-level and/or L3-level inference of RSRP, reference signal received quality (RSRQ), and/or signal to interference and noise ratio (SINR) (where L1-level may be at a beam-level (L1-RSRP, L1-SINR) and L3-level may be at either beam-level or cell-level (RSRP, RSRQ, SINR)), failure event prediction (e.g., beam level failure (BFD) prediction for serving and/or neighboring cells and cell level failure (e.g., RLF) prediction for serving and/or neighboring cells), data related prediction (e.g., cell load prediction, DL and/or UL throughput prediction (where the cell load prediction may be used), packet loss rate prediction, packet latency prediction, blockage prediction), cell switch KPI related prediction (e.g., cell switch failure prediction, cell switch latency prediction, measurement report to HO command (such as a gNB processing latency which is out of the UE's control), HO command to HO completion (based on a time associated with each of UE reconfiguration, DL synchronization latency, and UL synchronization latency), measurement report to HO completion (e.g., a time between a measurement report and a HO completion, including an intervening HO command)). The data available at the UE may also include one or more of L1/L3 channel measurement history (RSRP, RSRQ, SINR, received signal strength indicator (RSSI)), cell search history (PCI lists across different RATs (LTE, NR)), cell switch history and related KPIs (L3 HO, CHO, LTM, C-LTM) (e.g., cell switch success/failure rate (early or late HO), RLF rate, ping-pong switches, intra-frequency and/or inter-frequency HOs), data connection statistics (e.g., DL/UL throughput, latency, packet error rate, packet loss rate, L2 packet discard (MAC/RLC/PDCP)), and UE internal conditions (e.g., UE hardware and/or software design restrictions, RF power limitations (maximum permissible exposure (MPE), maximum transmit power level (MTPL), specific absorption rate (SAR)), RF band combinations, thermal condition, UE specification between capacity (throughput) and coverage (reliability), UE internal and/or original equipment manufacturer (OEM) metric, UE single subscriber identity modules (SIM) or multi-SIM restrictions). Based on the information such as statistical observations over time, sensor information, and AI/ML-based prediction data, providing the network with a UE's assistance/request information based on the additional information available at the UE may improve overall latency and reliability of the LTM procedure.

Additionally, using AI/ML based RRM measurement and event prediction, some aspects may address some issues arising from the reactive nature of legacy HO mechanism, e.g., a base station may trigger HO to neighbor cell after receiving the degraded RSRP measurement reports, by allowing mobility based on a prediction-based proactive schemes. In some aspects, from the seamless service continuity point of view, a UE's autonomous decision on LTM cell switch execution, e.g., preemption of command, may further improve the mobility performance significantly.

Various aspects relate generally to LTM enhancements. The LTM enhancements, in some aspects, may include, or relate to, one or more of a UE assisted LTM enhancement scheme which includes a UE providing an assistance information message and/or a request message, an action by a base station in response to the UE's assistance information message and/or the request message, and/or a UE's autonomous action and report (e.g., which may depend on a base station's response to the assistance information message and/or the request message transmitted by a UE). In some aspects, the LTM enhancements may include, or relate to, allowing the UE to ignore a CSC from the network and override the CSC or perform a different cell switch operation (e.g., a CHO or C-LTM). Allowing the UE to ignore a CSC may be associated with autonomous UE operation during an LTM cell switching procedure for overriding (e.g., preempting or modifying) the LTM behavior upon receiving the LTM CSC based on UE local information. In some examples, a wireless device may be configured to receive, from a first cell, a cell switch command associated with a first cell switch operation and override the cell switch command based on a cell switch preemption capability of the UE. In some examples, a network device may be configured to transmit, to a UE, a cell switch command associated with a first cell switch operation and receive, from the UE, an indication of an override of the cell switch command based on a cell switch preemption capability of the UE. In some examples, a wireless device may be configured to obtain mobility-related information and transmit, to a first cell and based on the mobility-related information, one or more of assistance information or a mobility-related request. In some examples, a network device may be configured to receive, from the UE, one or more of assistance information or a mobility-related request and transmit, or omit a transmission of, an additional indication of a response to one or more of the assistance information or the mobility-related request.

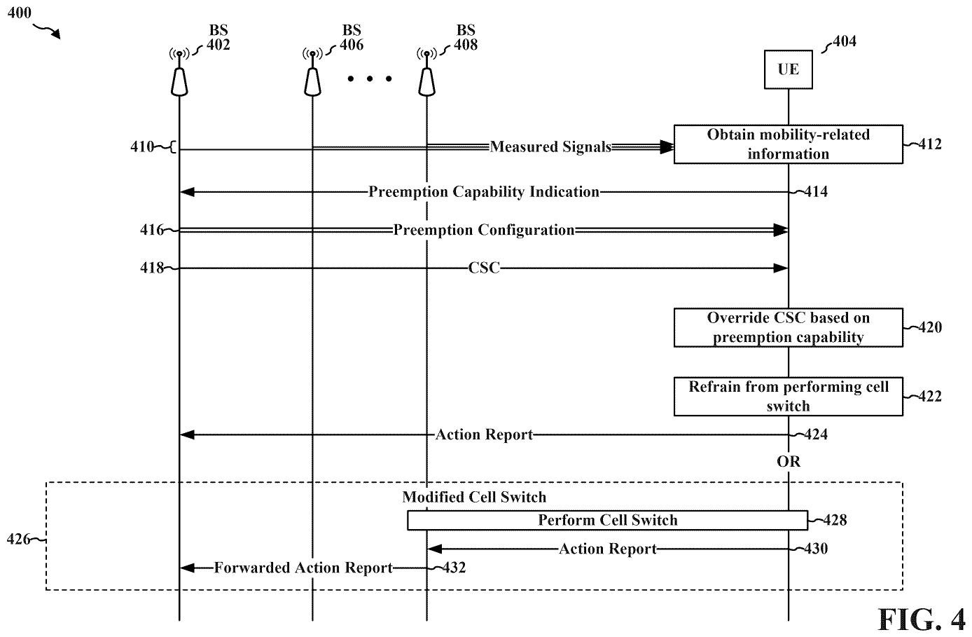

FIG. 4 is a call flow diagram 400 illustrating a method of wireless communication in accordance with some aspects of the disclosure. The method is illustrated in relation to a base station 402 (e.g., as an example of a network device or network node that may include one or more components of a disaggregated base station) in communication with a UE 404 (e.g., as an example of a wireless device). Additional neighboring base stations may include base station 406 and base station 408. The additional base stations may be candidates for cell switches and/or handovers for the UE 404 (which may be referred to as any of candidate cells, target candidate cells, or candidate target cells). The functions ascribed to the base station 402, in some aspects, may be performed by one or more components of a network entity, a network node, or a network device (a single network entity/node/device or a disaggregated network entity/node/device as described above in relation to FIG. 1). Similarly, the functions ascribed to the UE 404, in some aspects, may be performed by one or more components of a wireless device supporting communication with a network entity/node/device. Accordingly, references to “transmitting” in the description below may be understood to refer to a first component of the base station 402 (or the UE 404) outputting (or providing) an indication of the content of the transmission to be transmitted by a different component of the base station 402 (or the UE 404). Similarly, references to “receiving” in the description below may be understood to refer to a first component of the base station 402 (or the UE 404) receiving a transmitted signal and outputting (or providing) the received signal (or information based on the received signal) to a different component of the base station 402 (or the UE 404).

The base stations 402, 406, and 408, in some aspects, may transmit one or more signals 410 that are measured by the UE to obtain, at 412, mobility related information. The mobility-related information, in some aspects, may include AI/ML based prediction information, L1/L3 channel measurement history, cell search history, cell switch history and related KPIs, data connection statistics, and/or UE internal condition(s). The AI/ML based prediction information, in some aspects, may include one or more of measurement prediction, L1-level and/or L3-level inference of RSRP, RSRQ, and/or SINR (where L1-level may be at a beam-level (L1-RSRP, L1-SINR) and L3-level may be at either beam-level or cell-level (RSRP, RSRQ, SINR)), failure event prediction (e.g., BFD prediction for serving and/or neighboring cells and cell level failure (e.g., RLF) prediction for serving and/or neighboring cells), data related prediction (e.g., cell load prediction, DL and/or UL throughput prediction (where the cell load prediction may be used), packet loss rate prediction, packet latency prediction, blockage prediction), cell switch KPI related prediction (e.g., cell switch failure prediction, cell switch latency prediction, measurement report to HO command (such as a gNB processing latency which is out of the UE's control), HO command to HO completion (based on a time associated with each of UE reconfiguration, DL synchronization latency, and UL synchronization latency), measurement report to HO completion (e.g., a time between a measurement report and a HO completion, including an intervening HO command)). The data available at the UE may also include one or more of L1/L3 channel measurement history (RSRP, RSRQ, SINR, RSSI), cell search history (PCI lists across different RATs (LTE, NR)), cell switch history and related KPIs (L3 HO, CHO, LTM, C-LTM) (e.g., cell switch success/failure rate (early or late HO), RLF rate, ping-pong switches, intra-frequency and/or inter-frequency HOs), data connection statistics (e.g., DL/UL throughput, latency, packet error rate, packet loss rate, L2 packet discard (MAC/RLC/PDCP)), and UE internal conditions (e.g., UE hardware and/or software design restrictions, RF power limitations (MPE, MTPL, SAR), RF band combinations, thermal condition, UE specification between capacity (throughput) and coverage (reliability), UE internal and/or OEM metric, UE single SIM or multi-SIM restrictions). Based on the information such as statistical observations over time, sensor information, and AI/ML-based prediction data, providing the network with a UE's assistance/request information based on the additional information available at the UE may improve overall latency and reliability of the LTM procedure.

The UE 404 may transmit, and the base station 402 may receive, a preemption capability indication 414. In some aspects, the capability indication may be a static capability indication (e.g., transmitted via an information element (IE) such as UECapabilityInformation) and/or a dynamic capability indication (e.g., via UEAssistanceInformation, or UAI). The preemption capability indication 414, in some aspects, may indicate support for a cell switch preemption capability (e.g., a capability to override one or more values associated with a cell switch command received by the UE). The cell switch preemption capability, in some aspects, may be associated with a capability at the UE to refrain from performing an indicated cell switch. For example, the preemption capability can be exchanged as part of UE capability information. In some aspects, the preemption capability and/or a preemption operation may be allowed and/or disallowed by the base station 402.

Based on the preemption capability indication 414, the base station 402 may transmit, and the UE 404 may receive, one or more preemption configurations 416. In some aspects, the one or more preemption configurations 416 may be associated with semi-static control via RRC and the preemption permission and/or allowance may be a common, or global, parameter associated with LTM operations generally, i.e., a single parameter to be applied across LTM switches and/or CSCs. The semi static control, in some aspects, may include a preemption permission and/or allowance for each of one or more groups of candidate cells for an LTM switch (e.g., candidate target cells that may be associated with a CSC). In some aspects, the preemption capability may be indicated for a single candidate cell (e.g., as a group of one or if permission and/or allowance is allowed for single cells). While discussed in terms of permission and/or allowance, in some aspects, the one or more preemption configurations 416 may include at least one indication and/or configuration forbidding or disallowing preemption (e.g., generally or for one or more groups of candidate cells). In some aspects, the one or more preemption configurations 416 may be associated with dynamic control via lower layer signaling. For example, the base station 402 may signal the permissibility, allowance, and/or availability (or forbiddance, disallowance, or unavailability) of the LTM cell switch command preemption via DCI or MAC CE.

The base station 402 may transmit, and the UE 404 may receive, a CSC 418 indicating for the UE 404 to perform an LTM cell switch operation with one of base station 406 or base station 408 (e.g., a target cell selected and/or identified from a set of candidate cells). In some aspects, the CSC 418 may include the dynamic indication of the permissibility or allowance of the LTM cell switch command preemption (e.g., the LTM CSC may be extended to include a field to indicate whether UE is allowed to perform the preemption or not). The dynamic indication, in some aspects, may apply to a specific CSC (e.g., the CSC including the dynamic indication) and may override a semi-static indication relating to LTM generally, to LTM for a group of cells to which the serving cell or target cell belong, or to LTM for a specific cell. In some aspects, the CSC 418 may be a conditional CSC indicating a triggering condition for a cell switch and one or more target cells (e.g., a set of candidate cells). While primarily discussed in terms of a LTM cell switch, the CSC 418, in some aspects, may be associated with any of an LTM cell switch, a C-LTM cell switch, a L3 HO, or a L3 CHO.

Assuming that the preemption capability is permitted and/or allowed for the CSC 418, the UE may, at 420, override the cell switch command based on the cell switch preemption capability of the UE indicated by the preemption capability indication 414. Overriding the cell switch command at 420 based on the cell switch preemption capability of the UE, in some aspects, may include one or more of refraining, at 422, from performing the cell switch operation associated with the CSC 418, or overriding one or more values for one or more parameters associated with the cell switch command and performing, at 426, a modified cell switch operation (e.g., may perform, at 428, a second cell switch operation with one or more modified parameters to an indicated target cell or to a different, UE-selected, target cell).

Based on refraining, at 422, from performing the indicated cell switch, the UE 404 may transmit, and the base station 402 may receive, an action report 424 indicating that the UE 404 did not perform the LTM switch indicated in the CSC 418 (e.g., indicating the LTM switch preemption). In some aspects, the UE 404 may start a timer and wait for another CSC from the base station 402. The timer, in some aspects, may be configured by the base station (e.g., via RRC signaling), known (e.g., pre-configured), or determined by the UE (e.g., autonomously). Upon the expiration of the timer, the UE may be configured, or may determine (or choose), to perform the modified cell switch at 426.

As discussed above, when performing the modified cell switch at 426 based on either the overriding at 420 or the expiration of a timer following the action report 424, the UE may override one or more values for one or more parameters associated with the cell switch command. For example, the one or more values may include an identifier of a target cell and the modified cell switch performed at 426 may be based on overriding the target cell identifier and the UE 404 may perform, at 428, a second cell switch operation to a UE-selected target cell (e.g., base station 408) that is different from a first target cell (e.g., base station 406) indicated in the cell switch command (e.g., may perform the second cell switch operation that is not indicated in the cell switch command). In some aspects, the one or more parameters relate to one or more of a first target cell indicated in the cell switch command, whether to perform a random access channel (RACH) based cell switch, an index of a SSB, a transmission configuration indicator, or a TA value whether the target cell is the same as, or different from, a target cell identified in the CSC 418.

For example, after overriding and/or preempting the LTM cell switch command, a UE may perform one of the following mobility actions. First, the UE may perform a conditional LTM (e.g., when the CSC 418 is associated with a C-LTM operation) towards a new target cell that the UE selects (e.g., picks on its own). This first possibility, in some aspects, may be available when the UE is configured with C-LTM configurations. This first possible form of overriding and/or preempting the CSC, may be defined, indicated and/or specified as part of one or more triggering condition(s) for the C-LTM. For example, the UE may override an indicated target candidate cell, e.g., based on the indicated target cell having been measured to have a bad channel quality. When the indicated target candidate cell is chosen to be overridden, the UE (in performing the cell switch at 428) may move directly to an LTM recovery phase during which the UE searches (or looks) for a candidate cell (a cell with a channel, or signal, quality and/or signal strength that is greater than a threshold or better quality and/or strength than other cells measured by the UE) and attempt a RACH procedure and/or operation towards an identified (or found) candidate target cell (e.g., perform a RACH, or initial access, operation to connect with, or camp on, the identified candidate target cell (e.g., an updated target cell)). In some aspects, this may allow the UE to skip or avoid the unnecessary interruption based on attempting the indicated LTM operation to a target cell the UE knows will fail, indicating the failure to the base station, and receiving a new CSC (e.g., avoiding an LTM execution→RLF declaration after LTM switch→new CSC and/or LTM execution).

In some aspects, the first action may include overriding an indication to perform one of a LTM cell switch, a C-LTM cell switch, a L3 HO, or a L3 CHO to perform another of the LTM cell switch, the C-LTM cell switch, the L3 HO, or the L3 CHO. For example, overriding the one or more values may include refraining from performing a first cell switch operation associated with the L3 handover (indicated in the CSC 418) and performing a second cell switch operation associated with the C-LTM (or L3 CHO), e.g., where the C-LTM (or L3 CHO) have been previously configured for, or at, the UE. In some aspects, overriding the one or more values may include refraining from performing a first cell switch operation associated with the LTM (indicated in the CSC 418) and performing a second cell switch operation associated with one of the C-LTM or the L3 CHO, e.g., where the C-LTM and/or the L3 CHO have been previously configured for, or at, the UE. If both the C-LTM and the L3 CHO are, or have been, configured at the UE, rules for priority handling may be configured via RRC signaling or may be known (pre-configured) and may be absolute or conditional.

Second, the UE may override (or preempt) one or more values of, or for, one or more of parameters included in, or indicated by, the CSC 418 to values (autonomously) selected by the UE. In some aspects, the one or more values of, or for, the one or more parameters may include a value indicating to perform a RACH-less LTM operation and/or cell switch, a value for an SSB index, a value for a TCI state ID, or a TA value. For example, a value indicating for the UE to perform the RACH-less LTM operation and/or cell switch (e.g., a cell switch without an initial access and/or RACH procedure with the target cell based on a TA value and/or TCI state ID indicated in the CSC) may be overridden based on knowledge (e.g., obtained at 412) at the UE that the TA value and/or TCI state ID indicated in the CSC are not accurate and/or are not usable (e.g., are bad) and the UE may determine (or choose) to perform a RACH-based LTM operation, where an SSB index associated with the RACH-based LTM operation may (autonomously) selected by the UE. In some aspects, any of the SSB index, the TCI state ID, and/or the TA value may be overridden with a UE-selected value based on information available at the UE (e.g., the mobility-related information obtained at 412). The first and second possibilities for overriding the one or more values for the one or more parameters, in some aspects, may be combined, e.g., values associated with a target cell and at least one other parameter may both/all be overridden.

Based on overriding the one or more values at 420, the UE 404 may perform a modified cell switch at 426 and/or 428, the UE 404 may transmit an action report to a current serving cell (e.g., base station 402 for action report 424 or base station 408 for action report 430) after the response of the UE 404 to the CSC 418. In some aspects, the base station 408 may forward the action report 430 as forwarded action report 432 to base station 402. Base station 402 may, based on action report 424 or forwarded action report 432, be able to identify an action taken and/or a cause for the CSC preemption. For example, the action report 424 and/or 430 may include one or more of a reason code for preemption (e.g., an indication of why the CSC was preempted and/or overridden), an action code (e.g., an indication of the value overridden or the action taken by the UE, such as staying in the current serving cell, choosing a different cell, etc.), a candidate target cell or group of cells, metric(s) for listed candidate cells (e.g., L1-/L3-RSRP, RSRQ, SINR, latency), and/or metric(s) associated with a target cell indicated in the CSC 418. In some aspects, the determination to override (or preempt) the CSC 418 may be based on the mobility-related information obtained at 412.

The action report message, in some aspects, may be implemented in RRC or MAC signaling (e.g., RRC signaling or a MAC-CE). The message may be sent directly to the serving cell (e.g., if no cell switch operation is performed) or indirectly through the (non-indicated) target cell (e.g., if the target cell is overridden as for the forwarded action report 432). The message forwarding to a service management and orchestration (SMO) may be performed by the serving cell or the target cell, (e.g., directly to the serving cell in the case that the UE decides to not perform a cell switch, or indirectly through the target cell in the case that the UE performs the cell switch to a different cell than the indicated target cell).

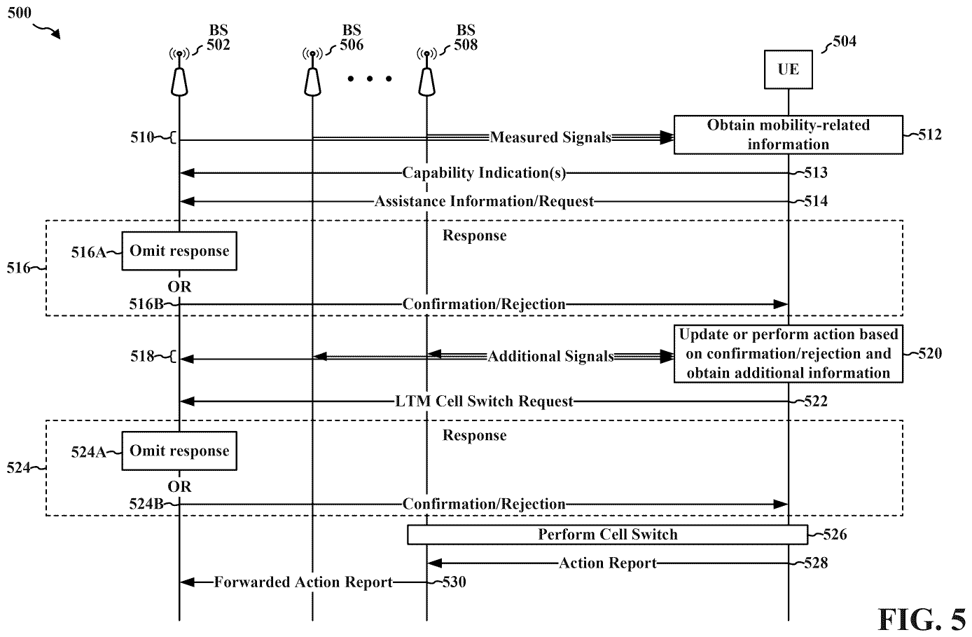

FIG. 5 is a call flow diagram 500 illustrating a method of wireless communication in accordance with some aspects of the disclosure. The method illustrated in FIG. 5, in some aspects, may be practiced in combination with the method illustrated in FIG. 4. The method is illustrated in relation to a base station 502 (e.g., as an example of a network device or network node that may include one or more components of a disaggregated base station) in communication with a UE 504 (e.g., as an example of a wireless device). Additional neighboring base stations may include base station 506 and base station 508. The additional base stations may be candidates for cell switches and/or handovers for the UE 504. The functions ascribed to the base station 502, in some aspects, may be performed by one or more components of a network entity, a network node, or a network device (a single network entity/node/device or a disaggregated network entity/node/device as described above in relation to FIG. 1). Similarly, the functions ascribed to the UE 504, in some aspects, may be performed by one or more components of a wireless device supporting communication with a network entity/node/device. Accordingly, references to “transmitting” in the description below may be understood to refer to a first component of the base station 502 (or the UE 504) outputting (or providing) an indication of the content of the transmission to be transmitted by a different component of the base station 502 (or the UE 504). Similarly, references to “receiving” in the description below may be understood to refer to a first component of the base station 502 (or the UE 504) receiving a transmitted signal and outputting (or providing) the received signal (or information based on the received signal) to a different component of the base station 502 (or the UE 504).

The base stations 502, 506, and 508, in some aspects, may transmit one or more signals 510 that are measured by the UE to obtain, at 512, mobility related information. The mobility-related information, in some aspects, may include AI/ML based prediction information, L1/L3 channel measurement history, cell search history, cell switch history and related KPIs, data connection stats, UE internal condition(s). The AI/ML based prediction information, in some aspects, may include one or more of measurement prediction, L1-level and/or L3-level inference of RSRP, RSRQ, and/or SINR (where L1-level may be at a beam-level (L1-RSRP, L1-SINR) and L3-level may be at either beam-level or cell-level (RSRP, RSRQ, SINR)), failure event prediction (e.g., BFD prediction for serving and/or neighboring cells and cell level failure (e.g., RLF) prediction for serving and/or neighboring cells), data related prediction (e.g., cell load prediction, DL and/or UL throughput prediction (where the cell load prediction may be used), packet loss rate prediction, packet latency prediction, blockage prediction), cell switch KPI related prediction (e.g., cell switch failure prediction, cell switch latency prediction, measurement report to HO command (such as a gNB processing latency which is out of the UE's control), HO command to HO completion (based on a time associated with each of UE reconfiguration, DL synchronization latency, and UL synchronization latency), measurement report to HO completion (e.g., a time between a measurement report and a HO completion, including an intervening HO command)). The data available at the UE may also include one or more of L1/L3 channel measurement history (RSRP, RSRQ, SINR, RSSI), cell search history (PCI lists across different RATs (LTE, NR)), cell switch history and related KPIs (L3 HO, CHO, LTM, C-LTM) (e.g., cell switch success/failure rate (early or late HO), RLF rate, ping-pong switches, intra-frequency and/or inter-frequency HOs), data connection statistics (e.g., DL/UL throughput, latency, packet error rate, packet loss rate, L2 packet discard (MAC/RLC/PDCP)), and UE internal conditions (e.g., UE hardware and/or software design restrictions, RF power limitations (MPE, MTPL, SAR), RF band combinations, thermal condition, UE specification between capacity (throughput) and coverage (reliability), UE internal and/or OEM metric, UE single SIM or multi-SIM restrictions). Based on the information such as statistical observations over time, sensor information, and AI/ML-based prediction data, providing the network with a UE's assistance/request information based on the additional information available at the UE may improve overall latency and reliability of the LTM procedure.

The UE 504 may transmit, and the base station 502 may receive, one or more UE capability indications 513 indicating a capability to provide assistance information and/or mobility-related requests based on mobility-related information obtained, e.g., at 512, by the UE. A capability indication of the one or more UE capability indications 513, in some aspects, may indicate whether the UE supports a transmission of at least one of the assistance information or the mobility-related request. In some aspects, the capability indication may be a static capability indication (e.g., transmitted via an information element (IE) such as UECapabilityInformation) and/or a dynamic capability indication (e.g., via UEAssistanceInformation, or UAI). For example, a static capability indication may indicate that a UE is capable of transmitting at least one of the assistance information or the mobility-related request in the absence of other limiting factors (e.g., power limitations, lack of observations, etc.) while a dynamic capability indication may fulfill the same function as a static capability indication and/or may indicate that the UE is currently capable of transmitting at least one of the assistance information or the mobility-related request. For example, in some aspects, the one or more UE capability indications 513 may include a static capability indication indicating that a UE is capable of transmitting at least one of the assistance information or the mobility-related request in the absence of other limiting factors and a dynamic capability indication indicating one or more functionalities associated with at least one of the assistance information or the mobility-related request supported by the UE. For example, the dynamic capability indication may indicate one or more active, or activated, functions that are supported, or allowed, by the UE based on current conditions. In some aspects, the one or more UE capability indications 513 may include additional capability indications (e.g., the preemption capability indication 414 of FIG. 4).

The UE 504 may transmit, and the base station 502 may receive, a message 514 including one the assistance information or the mobility-related request. The message 514, in some aspects, may be transmitted via RRC signaling and/or a MAC-CE. In some aspects, the message 514 may include one or more of (1) a suitable list of LTM candidate cells (e.g., assistance information sent to the base station 502 to assist the base station 502 to determine the candidate cells for LTM configuration), (2) a configured LTM candidate cell update request (e.g., a request for the base station 502 to add and/or remove one or more cells from a (current) set of candidate cells associated with, or configured for, LTM), (3) a candidate TCI state activation request (e.g., a request for the base station 502 to trigger, at the UE, the activation of TCI state for a candidate cell), (4) an early UL synchronization RACH request (e.g., a request to trigger PDCCH-ordered RACH for a candidate cell), (5) a LTM cell switch request (e.g., a request to trigger a LTM cell switch command towards a candidate cell), (5) C-LTM candidate target cell information (e.g., information regarding one or more potential candidate target cells for conditional LTM).

The message 514, in some aspects, may include one of a reason code (e.g., to indicate to the base station 502 the reason for the message 514) or an action code (e.g., to indicate to the base station 502 an action to be performed by the UE if the UE fails to receive a response to one or more of the assistance information or the mobility-related request within a response window). The reason code, for example, may indicate that one or more of (1) a serving cell's quality has become worse than a threshold quality, (2) a target cell's quality has become better than one of a threshold quality or a serving cell's quality plus an offset (e.g., a signal from the target cell is at least “X” dB stronger than a serving cell's signal, where X is the offset), (3) one or more better candidate cells and/or TCI state IDs have been identified (e.g., have been newly detected, or have become associated with at least a threshold quality and/or signal strength), or (4) an activated candidate cell's TCI state ID becomes worse (e.g., a signal quality and/or strength associated with the TCI state ID has fallen below a threshold). The action code, in some aspects, may indicate one of (1) conditional LTM execution towards one of the indicated candidate target cells (e.g., using a particular corresponding beam associated with the candidate target cell) or (2) autonomous TCI state activation with one of the indicated candidate target cells (e.g., using a correspond beam associated with the candidate target cell and/or the TCI state, where the TCI state may be selected by the UE). In some aspects, the message 514 may include an indication of a timer (e.g., a duration) associated with a response window from the transmission of the message 514 until an execution of the action indicated in the message 514.

In some aspects, the message 514 may include one or more of list(s) of candidate cell IDs, list(s) of SSB or TCI states IDs associated with the candidate cell IDs, list(s) of measurement metrics (e.g., L1 beam-level measurement quantity (L1-RSRP, L1-SINR), or L3 beam-level or cell level measurement quantity (RSRP, RSRQ, SINR)) associated with the SSB or TCI state IDs, list(s) of predicted metric(s) (e.g., based on one or more AI/ML model inferences) associated with the SSB or TCI state IDs.

The base station 502, based on receiving the message 514, may, at 516, respond to the message 514. In some aspects, if the message 514 includes a request for (or an indication of) an (autonomous) action to be taken by the UE 504, and the base station 502 has determined to allow the action (or that the action is allowed), the base station 502 may, at 516A, omit a response during a response window. In some aspects, omitting a response at 516A, may indicate a confirmation of one or more of (1) the suitable list of LTM candidate cells, (2) the configured LTM candidate cell update request, (3) the candidate TCI state activation request, (4) the early UL synchronization RACH request, (5) the LTM cell switch request, (5) or the C-LTM candidate target cell information. In some aspects, the base station 502 may transmit, and the UE 504 may receive, an (explicit) response 516B. The response 516B, in some aspects, may include a message incorporating the assistance information and/or the requested changes/updates included and/or requested in the message 514. For example, the base station 502 may transmit, as response 516B, one of (1) an RRC reconfiguration with an (updated) LTM configuration reflecting candidate cells from the suitable list of LTM candidate cells and/or the configured LTM candidate cell update request included in message 514, (2) a candidate cell TCI states activation/deactivation MAC-CE for candidate cells and/or beams (e.g., beams corresponding to, or associated with, candidate target cells and/or TCI states) specified in the candidate TCI state activation request included in the message 514, or (3) a PDCCH-order for RACH towards a candidate cell and/or beam (e.g., a beam identified by, or associated with, a SSB) specified in the early UL synchronization RACH request included in the message 514.

In some aspects, the response 516B may indicate that the request is one of allowed or disallowed (e.g., accepted/confirmed or rejected). For example, the information included in the message 514 (e.g., one or more candidate cell IDs and/or beam IDs (SSB or TCI state IDs) may be provided in the response 516B as an indication that the request is allowed, accepted, and/or confirmed. If the information included in the response 516B (e.g., one or more candidate cell IDs and/or beam IDs (SSB or TCI state IDs)) is not the same as the information included in the message 514, the response 516B may indicate that the request was not allowed (was disallowed) or rejected and the information included in the response 516B may be interpreted as a recommendation or alternative to the request in message 514. In some aspects, the response 516B may be DCI or a MAC-CE.

Based on the response at 516 (e.g., based on failing to receive a response based on the base station 502 omitting the response at 516A or based on receiving the response 516B), the UE 504 may, at 520, update a configuration or perform an action (or refrain from updating the configuration or performing the action) associated with the message 514 as described above. A set of additional signals 518 may be associated with the updating the configuration or performing the action at 520 (e.g., may be related to an early RACH or an activated TCI state). For example, the additional signals may include a report of an autonomous action taken by the UE 504 (e.g., an autonomous TCI state activation performed, or executed, by the UE 504). If the autonomous action taken by the UE 504 does not include switching to a different cell, the report (similar to action report 528 discussed below, or action report 424 of FIG. 4) may be transmitted to the base station 502. The set of additional signals 518, in some aspects, may, be measured and/or monitored by the UE 504 at 520 to obtain additional information (e.g., mobility-related information).

Based on the additional mobility-related information, the UE 504 may transmit, and the base station 502 may receive, a request 522 for a LTM switch to a particular target cell. The base station 502, based on receiving the request 522, may, at 524, respond to the request 522. In some aspects, if the base station 502 has determined to allow the action (or that the action is allowed), the base station 502 may, at 524A, omit a response during a response window. In some aspects, the base station may transmit, and the UE 504 may receive, the response 524B indicating that the request is one of allowed or disallowed (e.g., accepted/confirmed or rejected). If the request is indicated to be allowed via one of the base station 502 omitting the response at 524A or transmitting the response 524B (or if a disallowance includes a recommended target cell such as the base station 508 or a cell associated with the base station 508) the UE 504 may, at 526, perform a cell switch with, or to, the base station 508 (e.g., a LTM cell switch with the base station 508 as the target cell). The UE 504 may, based on executing the LTM cell switch, transmit, and the base station 508 may receive, an action report 528. The base station 508, may then forward the action report 528 as forwarded action report 530. As described above in relation to additional signals and in relation to action report 528, in some aspects, an autonomous action report message, may be sent directly to the serving cell (e.g., base station 502) or through a target cell (e.g., base station 508). For example, an autonomous TCI state activation and an autonomous conditional LTM execution may be reported to a serving cell and a target cell, respectively. While discussed in relation to LTM, the assistance information, requests, and autonomous action, in some aspects, may relate to L3 HO and L3 CHO as discussed in relation to FIG. 4 above.

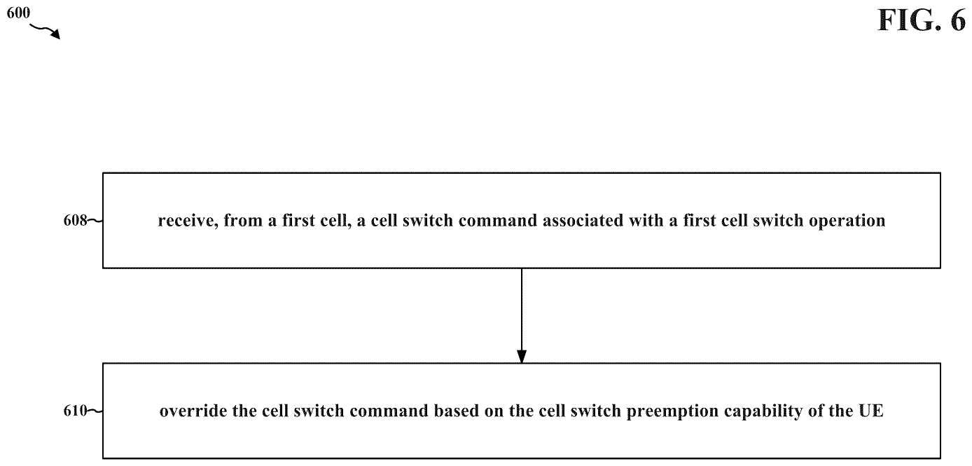

FIG. 6 is a flowchart 600 of a method of wireless communication. The method may be performed by a UE (e.g., the UE 104, 404, 504; the apparatus 1404). In some aspects, the UE may transmit, to a first cell, an indication of support for the cell switch preemption capability prior to a reception of a cell switch command. In some aspects, the indication of support for the cell switch preemption capability, may be transmitted in UE capability information. For example, referring to FIG. 4, the UE 404 may transmit, and the base station 402 may receive, the preemption capability indication 414.

In some aspects, the UE may receive, from the first cell, an additional indication that the cell switch preemption capability is one of allowed or disallowed by the first cell. In some aspects, the additional indication may be included in a RRC message and applies to one of LTM for the UE or one or more groups of one or more LTM candidate cells. The additional indication, in some aspects, may be included in one of DCI, a MAC-CE, or a LTM cell switch command (e.g., a LTM CSC to which it applies). For example, referring to FIG. 4, the UE 404 may receive, and the base station 402 may transmit, the preemption configurations 416.

The UE, in some aspects, may obtain mobility-related information. The mobility-related information, in some aspects, may include one or more of a channel measurement history associated with one or more cells, a cell search history, a cell switch history, one or more key performance indicators associated with the cell search history, dual connection statistics, an internal condition of the UE, or one or more AI/ML predictions. In some aspects, the mobility-related information may be used to determine whether, or how, to override one or more values for one or more parameters associated with a CSC. For example, referring to FIG. 4, the UE 404 may obtain, at 412, mobility-related information.

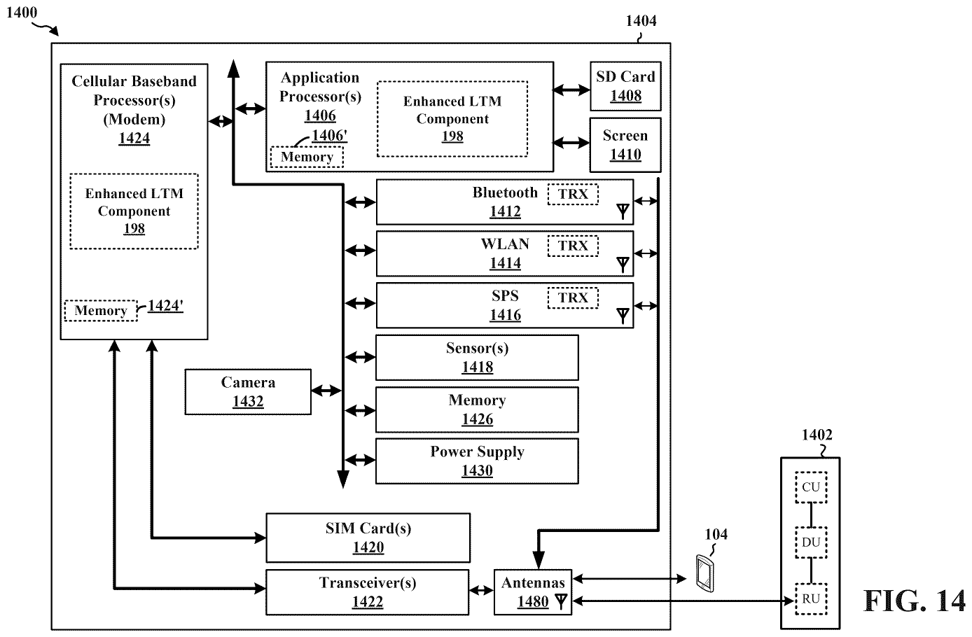

At 608, the UE may receive, receiving, from the first cell, a cell switch command associated with a first cell switch operation. For example, 608 may be performed by application processor(s) 1406, cellular baseband processor(s) 1424, transceiver(s) 1422, antenna(s) 1480, and/or enhanced LTM component 198 of FIG. 14. In some aspects, the cell switch command may be associated with one of: a LTM, a conditional LTM, a L3 handover, or a conditional L3 handover. For example, referring to FIG. 4, the UE 404 may receive, and the base station 402 may transmit, the CSC 418.

At 610, the UE may override the cell switch command based on the cell switch preemption capability of the UE. In some aspects, overriding the cell switch command may include refraining from performing the first cell switch operation associated with the cell switch command, overriding one or more values for one or more parameters associated with the cell switch command, and/or performing a second cell switch operation to a UE-selected target cell that is different from the first target cell indicated in the cell switch command. In some aspects, the one or more parameters relate to one or more of a first target cell indicated in the cell switch command, whether to perform a RACH based cell switch, an index of a SSB, a TCI (or TCI state ID), or a TA value. The second cell switch operation, in some aspects, may not be indicated in the cell switch command. For example, 610 may be performed by application processor(s) 1406, cellular baseband processor(s) 1424, transceiver(s) 1422, antenna(s) 1480, and/or enhanced LTM component 198 of FIG. 14. In some aspects, overriding the cell switch command based on the cell switch preemption capability of the UE may include refraining from performing the first cell switch operation associated with the L3 handover and performing the second cell switch operation associated with the conditional LTM or refraining from performing the first cell switch operation associated with the LTM and performing the second cell switch operation associated with one of the conditional LTM or the conditional L3 handover. In some aspects, the override of the cell switch command may be based on the mobility-related information. For example, referring to FIG. 4, the UE 404 may override, at 420, the cell switch command based on the cell switch preemption capability of the UE, where the overriding at 420 may include refraining, at 422, from performing the indicated cell switch and/or performing the modified cell switch at 426.

In some aspects, the UE may transmit, to the first cell, an indication of the override of the cell switch command based on the cell switch preemption capability of the UE. In some aspects, the indication may be transmitted, to one of the first cell (a direct transmission) or a target cell for a non-indicated cell switch triggered by the cell switch command (to be provided to the first cell by the target cell as part of an indirect transmission from the UE to the first cell). The indication, in some aspects, may be an indication relating to the override of the cell switch command, and the indication may relate to one or more of a reason for the override of the cell switch command, an action taken instead of performing the first cell switch operation, a candidate target cell, a candidate target group of cells, metrics for listed candidate cells, a metric for an indicated target cell in the cell switch command. For example, referring to FIG. 4, the UE 404 may receive, and the base station 402 may transmit, the action report 424 or the action report 430.

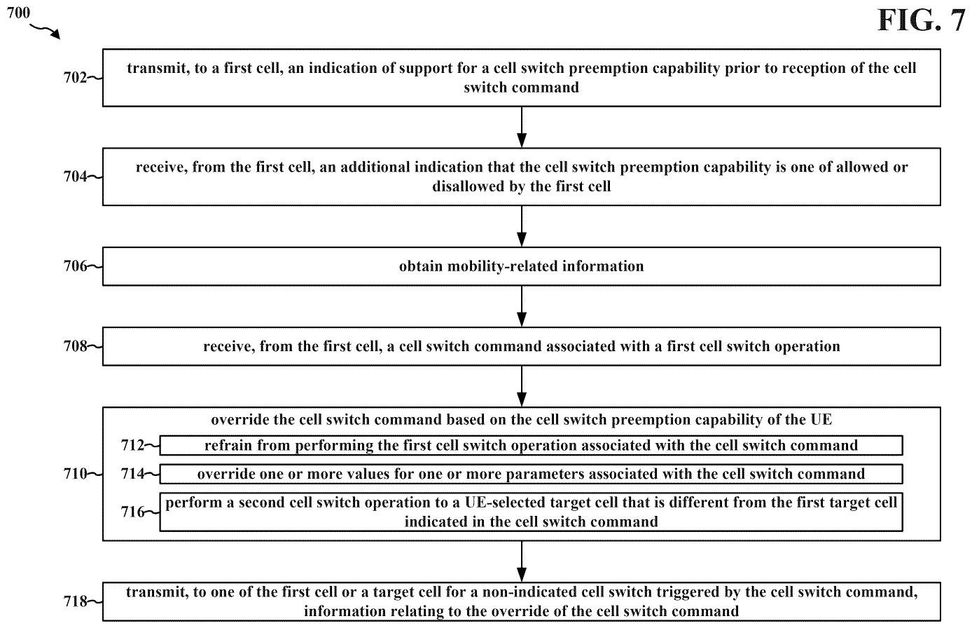

FIG. 7 is a flowchart 700 of a method of wireless communication. The method may be performed by a UE (e.g., the UE 104, 404, 504; the apparatus 1404). At 702, the UE may transmit, to a first cell, an indication of support for the cell switch preemption capability prior to a reception of a cell switch command. For example, 702 may be performed by application processor(s) 1406, cellular baseband processor(s) 1424, transceiver(s) 1422, antenna(s) 1480, and/or enhanced LTM component 198 of FIG. 14. In some aspects, the indication of support for the cell switch preemption capability, may be transmitted in UE capability information. For example, referring to FIG. 4, the UE 404 may transmit, and the base station 402 may receive, the preemption capability indication 414.

At 704, the UE may receive, from the first cell, an additional indication that the cell switch preemption capability is one of allowed or disallowed by the first cell. For example, 704 may be performed by application processor(s) 1406, cellular baseband processor(s) 1424, transceiver(s) 1422, antenna(s) 1480, and/or enhanced LTM component 198 of FIG. 14. In some aspects, the additional indication may be included in a RRC message and applies to one of LTM for the UE or one or more groups of one or more LTM candidate cells. The additional indication, in some aspects, may be included in one of DCI, a MAC-CE, or a LTM cell switch command (e.g., a LTM CSC to which it applies). For example, referring to FIG. 4, the UE 404 may receive, and the base station 402 may transmit, the preemption configurations 416.

At 706, the UE may obtain mobility-related information. For example, 706 may be performed by application processor(s) 1406, cellular baseband processor(s) 1424, transceiver(s) 1422, antenna(s) 1480, and/or enhanced LTM component 198 of FIG. 14. The mobility-related information, in some aspects, may include one or more of a channel measurement history associated with one or more cells, a cell search history, a cell switch history, one or more key performance indicators associated with the cell search history, dual connection statistics, an internal condition of the UE, or one or more AI/ML predictions. In some aspects, the mobility-related information may be used to determine whether, or how, to override one or more values for one or more parameters associated with a CSC. For example, referring to FIG. 4, the UE 404 may obtain, at 412, mobility-related information.

At 708, the UE may receive, receiving, from the first cell, a cell switch command associated with a first cell switch operation. For example, 708 may be performed by application processor(s) 1406, cellular baseband processor(s) 1424, transceiver(s) 1422, antenna(s) 1480, and/or enhanced LTM component 198 of FIG. 14. In some aspects, the cell switch command may be associated with one of: a LTM, a conditional LTM, a L3 handover, or a conditional L3 handover. For example, referring to FIG. 4, the UE 404 may receive, and the base station 402 may transmit, the CSC 418.

At 710, the UE may override the cell switch command based on the cell switch preemption capability of the UE. In some aspects, overriding the cell switch command may include refraining, at 712, from performing the first cell switch operation associated with the cell switch command, overriding, at 714, one or more values for one or more parameters associated with the cell switch command, and/or performing, at 716 a second cell switch operation to a UE-selected target cell that is different from the first target cell indicated in the cell switch command. In some aspects, the one or more parameters relate to one or more of a first target cell indicated in the cell switch command, whether to perform a RACH based cell switch, an index of a SSB, a TCI (or TCI state ID), or a TA value. The second cell switch operation, in some aspects, may not be indicated in the cell switch command. For example, 710, 712, 714, and 716 may be performed by application processor(s) 1406, cellular baseband processor(s) 1424, transceiver(s) 1422, antenna(s) 1480, and/or enhanced LTM component 198 of FIG. 14. In some aspects, overriding the cell switch command based on the cell switch preemption capability of the UE may include refraining from performing the first cell switch operation associated with the L3 handover and performing the second cell switch operation associated with the conditional LTM or refraining from performing the first cell switch operation associated with the LTM and performing the second cell switch operation associated with one of the conditional LTM or the conditional L3 handover. In some aspects, the override of the cell switch command may be based on the mobility-related information. For example, referring to FIG. 4, the UE 404 may override, at 420, the cell switch command based on the cell switch preemption capability of the UE, where the overriding at 420 may include refraining, at 422, from performing the indicated cell switch and/or performing the modified cell switch at 426.

At 718, the UE may transmit, to the first cell, an indication of the override of the cell switch command based on the cell switch preemption capability of the UE. For example, 718 may be performed by application processor(s) 1406, cellular baseband processor(s) 1424, transceiver(s) 1422, antenna(s) 1480, and/or enhanced LTM component 198 of FIG. 14. In some aspects, the indication may be transmitted, to one of the first cell (a direct transmission) or a target cell for a non-indicated cell switch triggered by the cell switch command (to be provided to the first cell by the target cell as part of an indirect transmission from the UE to the first cell). The indication, in some aspects, may be an indication relating to the override of the cell switch command, and the indication may relate to one or more of a reason for the override of the cell switch command, an action taken instead of performing the first cell switch operation, a candidate target cell, a candidate target group of cells, metrics for listed candidate cells, a metric for an indicated target cell in the cell switch command. For example, referring to FIG. 4, the UE 404 may receive, and the base station 402 may transmit, the action report 424 or the action report 430.

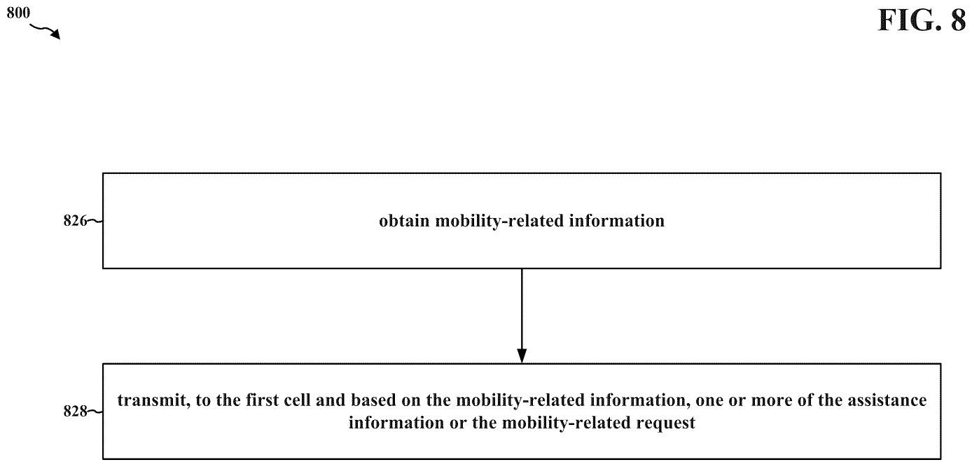

FIG. 8 is a flowchart 800 of a method of wireless communication. The method may be performed by a UE (e.g., the UE 104, 504, 504; the apparatus 1404). In some aspects, the UE may transmit, to a first cell, an indication of whether the UE supports a transmission of at least one of assistance information or a mobility-related request. In some aspects, the indication of whether the UE supports a transmission of at least one of assistance information or a mobility-related request may be transmitted in UE capability information. For example, referring to FIG. 5, the UE 504 may transmit, and the base station 502 may receive, the one or more UE capability indications 513.

The UE, in some aspects, may transmit, to the first cell, an additional indication of one or more functionalities associated with at least one of the assistance information or the mobility-related request supported by the UE. In some aspects, the additional indication may be included in UE assistance information. For example, referring to FIG. 5, the UE 504 may transmit, and the base station 502 may receive, the one or more UE capability indications 513.

At 826, the UE, in some aspects, may obtain mobility-related information. For example, 826 may be performed by application processor(s) 1406, cellular baseband processor(s) 1424, transceiver(s) 1422, antenna(s) 1480, and/or enhanced LTM component 198 of FIG. 14. The mobility-related information, in some aspects, may include one or more of a channel measurement history associated with one or more cells, a cell search history, a cell switch history, one or more key performance indicators associated with the cell search history, dual connection statistics, an internal condition of the UE, or one or more AI/ML predictions. In some aspects, the mobility-related information may be used to determine whether, or how, to override one or more values for one or more parameters associated with a CSC. For example, referring to FIG. 5, the UE 504 may obtain, at 512, mobility-related information.

At 828, the UE may transmit, to the first cell and based on the mobility-related information, one or more of assistance information or a mobility-related request. For example, 828 may be performed by application processor(s) 1406, cellular baseband processor(s) 1424, transceiver(s) 1422, antenna(s) 1480, and/or enhanced LTM component 198 of FIG. 14. In some aspects, one or more of the assistance information or the mobility-related request may include one or more of a first indication of a first set of candidate target cells for a LTM operation, a second indication of a second set of candidate target cells for a conditional LTM operation, a first request to update a current set of candidate target cells for the cell switch command, a second request to activate a transmission configuration indicator for a first candidate target cell, a third request for an early uplink random access channel synchronization, or a fourth request to initiate a LTM operation. One or more of the assistance information or the mobility-related request, in some aspects, may be associated with an indication of a reason for transmitting one or more of the assistance information or the mobility-related request, where the reason relates to one or more of: a first quality of a first signal from the first cell being less than a first threshold quality, a second quality of a second signal from at least one candidate target cell being greater than a second threshold quality, a first identification of a first set of cells that are better candidate target cells than at least a first candidate target cell in a current set of candidate target cells, a second identification of a second set of candidate target cells in the current set of candidate target cells that do not meet one or more criteria for being included in the current set of candidate target cells, a third identification of one or more TCIs that are better TCIs than one or more current TCIs, or a fourth identification of one or more activated TCIs that are associated with a third quality that is below a third threshold quality. In some aspects, one or more of the assistance information or the mobility-related request may be associated with an indication of an action to be performed by the UE if the UE fails to receive a response to one or more of the assistance information or the mobility-related request within a response window, and the UE is configured with a conditional LTM configuration associated with a set of candidate target cells and a corresponding set of beams, and where the action includes one or more of: a first conditional LTM cell switch operation based on the conditional LTM configuration towards a first candidate target cell in the set of candidate target cells and a corresponding beam selected by the UE that is not a first target cell indicated in the cell switch command, or a TCI state activation with a second candidate target cell in the set of candidate target cells and a beam selected by the UE. For example, referring to FIG. 5, the UE 504 may transmit, and the base station 502 may receive, one of message 514 or request 522.

In some aspects, the UE may receive, from the first cell, an indication of a response of the first cell to one or more of the assistance information or the mobility-related request. The response, in some aspects, may include one or more of an acceptance of one or more of the assistance information or the mobility-related request, a rejection of one or more of the assistance information or the mobility-related request, or an alternative to one or more of the assistance information or the mobility-related request. In some aspects, receiving the indication may include one of: receiving one of DCI or a MAC-CE indicating the response of the first cell, or failing to receive an explicit indication during a response window, where a failure to receive the explicit indication indicates the acceptance of one or more of the assistance information or the mobility-related request. In some aspects, a failure to receive an explicit indication further indicates for the UE to autonomously determine whether to take an action associated with one or more of the assistance information or the mobility-related request. For example, referring to FIG. 5, the UE 504 may receive, and the base station 502 may transmit, the response 516B or the response 524B or may fail to receive a response based on the omitting at 516A or 524A.

The UE, in some aspects, may perform the action associated with one or more of the assistance information or the mobility-related request. In some aspects, one or more of the assistance information or the mobility-related request may be associated with an indication of an action to be performed by the UE if the UE fails to receive a response to one or more of the assistance information or the mobility-related request within a response window, and the UE is configured with a conditional LTM configuration associated with a set of candidate target cells and a corresponding set of beams, and where the action includes one or more of: a first conditional LTM cell switch operation based on the conditional LTM configuration towards a first candidate target cell in the set of candidate target cells and a corresponding beam selected by the UE that is not a first target cell indicated in the cell switch command, or a TCI state activation (e.g., an autonomous TCI state activation) with a second candidate target cell in the set of candidate target cells and a beam selected by the UE. For example, referring to FIG. 5, the UE 504 may, at 520, update a configuration or perform an action (or refrain from updating the configuration or performing the action) associated with the message 514 or may, at 526 perform a cell switch with, or to, the base station 508 (e.g., a LTM cell switch with the base station 508 as the target cell).

In some aspects, the UE may transmit an additional indication of the action performed by the UE. The additional indication may be transmitted to the first cell (if no cell switch has been performed) or to a target cell for forwarding to the first cell (if a cell switch to the target cell has been performed). For example, referring to FIG. 5, the UE 504 may transmit, and the base station 502 may receive, an action report in the set of additional signals 518 (or the forwarded action report 530) or the UE 504 may transmit, and the base station 508 may receive, the action report 528.

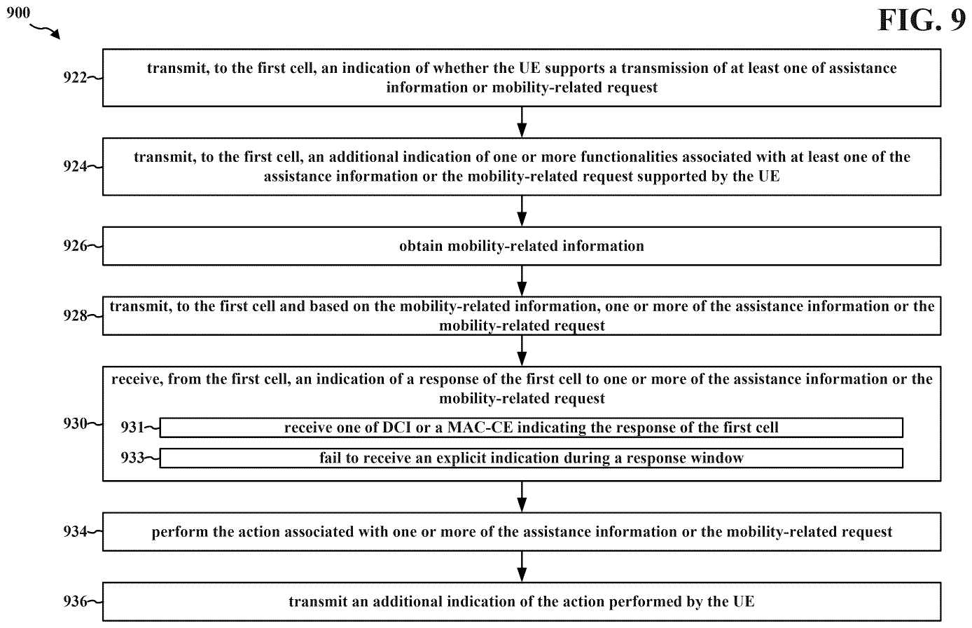

FIG. 9 is a flowchart 900 of a method of wireless communication. The method may be performed by a UE (e.g., the UE 104, 504, 504; the apparatus 1404). At 922, the UE may transmit, to a first cell, an indication of whether the UE supports a transmission of at least one of assistance information or a mobility-related request. For example, 922 may be performed by application processor(s) 1406, cellular baseband processor(s) 1424, transceiver(s) 1422, antenna(s) 1480, and/or enhanced LTM component 198 of FIG. 14. In some aspects, the indication of whether the UE supports a transmission of at least one of assistance information or a mobility-related request may be transmitted in UE capability information. For example, referring to FIG. 5, the UE 504 may transmit, and the base station 502 may receive, the one or more UE capability indications 513.

At 924, the UE may transmit, to the first cell, an additional indication of one or more functionalities associated with at least one of the assistance information or the mobility-related request supported by the UE. For example, 924 may be performed by application processor(s) 1406, cellular baseband processor(s) 1424, transceiver(s) 1422, antenna(s) 1480, and/or enhanced LTM component 198 of FIG. 14. In some aspects, the additional indication may be included in UE assistance information. For example, referring to FIG. 5, the UE 504 may transmit, and the base station 502 may receive, the one or more UE capability indications 513.

At 926, the UE, in some aspects, may obtain mobility-related information. For example, 926 may be performed by application processor(s) 1406, cellular baseband processor(s) 1424, transceiver(s) 1422, antenna(s) 1480, and/or enhanced LTM component 198 of FIG. 14. The mobility-related information, in some aspects, may include one or more of a channel measurement history associated with one or more cells, a cell search history, a cell switch history, one or more key performance indicators associated with the cell search history, dual connection statistics, an internal condition of the UE, or one or more AI/ML predictions. In some aspects, the mobility-related information may be used to determine whether, or how, to override one or more values for one or more parameters associated with a CSC. For example, referring to FIG. 5, the UE 504 may obtain, at 512, mobility-related information.

At 928, the UE may transmit, to the first cell and based on the mobility-related information, one or more of assistance information or a mobility-related request. For example, 928 may be performed by application processor(s) 1406, cellular baseband processor(s) 1424, transceiver(s) 1422, antenna(s) 1480, and/or enhanced LTM component 198 of FIG. 14. In some aspects, one or more of the assistance information or the mobility-related request may include one or more of a first indication of a first set of candidate target cells for a LTM operation, a second indication of a second set of candidate target cells for a conditional LTM operation, a first request to update a current set of candidate target cells for the cell switch command, a second request to activate a transmission configuration indicator for a first candidate target cell, a third request for an early uplink random access channel synchronization, or a fourth request to initiate a LTM operation. One or more of the assistance information or the mobility-related request, in some aspects, may be associated with an indication of a reason for transmitting one or more of the assistance information or the mobility-related request, where the reason relates to one or more of: a first quality of a first signal from the first cell being less than a first threshold quality, a second quality of a second signal from at least one candidate target cell being greater than a second threshold quality, a first identification of a first set of cells that are better candidate target cells than at least a first candidate target cell in a current set of candidate target cells, a second identification of a second set of candidate target cells in the current set of candidate target cells that do not meet one or more criteria for being included in the current set of candidate target cells, a third identification of one or more TCIs that are better TCIs than one or more current TCIs, or a fourth identification of one or more activated TCIs that are associated with a third quality that is below a third threshold quality. In some aspects, one or more of the assistance information or the mobility-related request may be associated with an indication of an action to be performed by the UE if the UE fails to receive a response to one or more of the assistance information or the mobility-related request within a response window, and the UE is configured with a conditional LTM configuration associated with a set of candidate target cells and a corresponding set of beams, and where the action includes one or more of: a first conditional LTM cell switch operation based on the conditional LTM configuration towards a first candidate target cell in the set of candidate target cells and a corresponding beam selected by the UE that is not a first target cell indicated in the cell switch command, or a TCI state activation with a second candidate target cell in the set of candidate target cells and a beam selected by the UE. For example, referring to FIG. 5, the UE 504 may transmit, and the base station 502 may receive, one of message 514 or request 522.

At 930, the UE may receive, from the first cell, an indication of a response of the first cell to one or more of the assistance information or the mobility-related request. The response, in some aspects, may include one or more of an acceptance of one or more of the assistance information or the mobility-related request, a rejection of one or more of the assistance information or the mobility-related request, or an alternative to one or more of the assistance information or the mobility-related request. In some aspects, receiving the indication at 930 may include one of: receiving, at 931, one of DCI or a MAC-CE indicating the response of the first cell, or failing, at 933, to receive an explicit indication during a response window, where a failure to receive the explicit indication indicates the acceptance of one or more of the assistance information or the mobility-related request. For example, 930, 931, and 933 may be performed by application processor(s) 1406, cellular baseband processor(s) 1424, transceiver(s) 1422, antenna(s) 1480, and/or enhanced LTM component 198 of FIG. 14. In some aspects, a failure to receive an explicit indication further indicates for the UE to autonomously determine whether to take an action associated with one or more of the assistance information or the mobility-related request. For example, referring to FIG. 5, the UE 504 may receive, and the base station 502 may transmit, the response 516B or the response 524B or may fail to receive a response based on the omitting at 516A or 524A.

At 934, the UE may perform the action associated with one or more of the assistance information or the mobility-related request. For example, 934 may be performed by application processor(s) 1406, cellular baseband processor(s) 1424, transceiver(s) 1422, antenna(s) 1480, and/or enhanced LTM component 198 of FIG. 14. In some aspects, one or more of the assistance information or the mobility-related request may be associated with an indication of an action to be performed by the UE if the UE fails to receive a response to one or more of the assistance information or the mobility-related request within a response window, and the UE is configured with a conditional LTM configuration associated with a set of candidate target cells and a corresponding set of beams, and where the action includes one or more of: a first conditional LTM cell switch operation based on the conditional LTM configuration towards a first candidate target cell in the set of candidate target cells and a corresponding beam selected by the UE that is not a first target cell indicated in the cell switch command, or a TCI state activation with a second candidate target cell in the set of candidate target cells and a beam selected by the UE. For example, referring to FIG. 5, the UE 504 may, at 520, update a configuration or perform an action (or refrain from updating the configuration or performing the action) associated with the message 514 or may, at 526 perform a cell switch with, or to, the base station 508 (e.g., a LTM cell switch with the base station 508 as the target cell).

At 936, the UE may transmit an additional indication of the action performed by the UE. For example, 936 may be performed by application processor(s) 1406, cellular baseband processor(s) 1424, transceiver(s) 1422, antenna(s) 1480, and/or enhanced LTM component 198 of FIG. 14. The additional indication may be transmitted to the first cell (if no cell switch has been performed) or to a target cell for forwarding to the first cell (if a cell switch to the target cell has been performed). For example, referring to FIG. 5, the UE 504 may transmit, and the base station 502 may receive, an action report in the set of additional signals 518 (or the forwarded action report 530) or the UE 504 may transmit, and the base station 508 may receive, the action report 528.

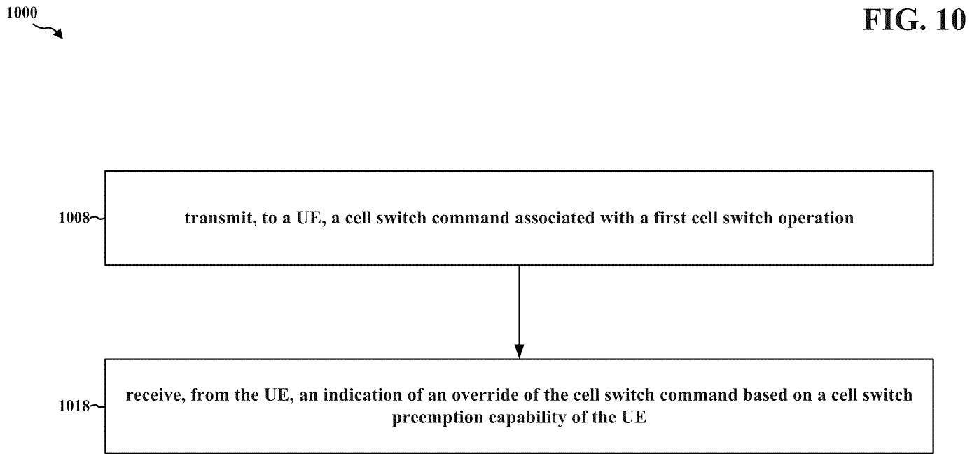

FIG. 10 is a flowchart 1000 of a method of wireless communication. The method may be performed by a network device such as a base station (e.g., the base station 102, 402, 502; the network entity 1402, 1502). In some aspects, the base station may receive, from the UE, a capability indication of support for the cell switch preemption capability of the UE prior to transmission of the cell switch command. The indication of support for the cell switch preemption capability, in some aspects, may be received in UE capability information. For example, referring to FIG. 4, the UE 404 may transmit, and the base station 402 may receive, the preemption capability indication 414.

The base station, in some aspects, may transmit, to the UE and in response to the capability indication, an additional indication that the cell switch preemption capability is one of allowed or disallowed. In some aspects, the additional indication may be included in a RRC message and applies to one of LTM for the UE or one or more groups of one or more LTM candidate cells. The additional indication, in some aspects, may be included in one of DCI, a MAC-CE, or a LTM cell switch command (e.g., a LTM CSC to which it applies). For example, referring to FIG. 4, the UE 404 may receive, and the base station 402 may transmit, the preemption configurations 416.

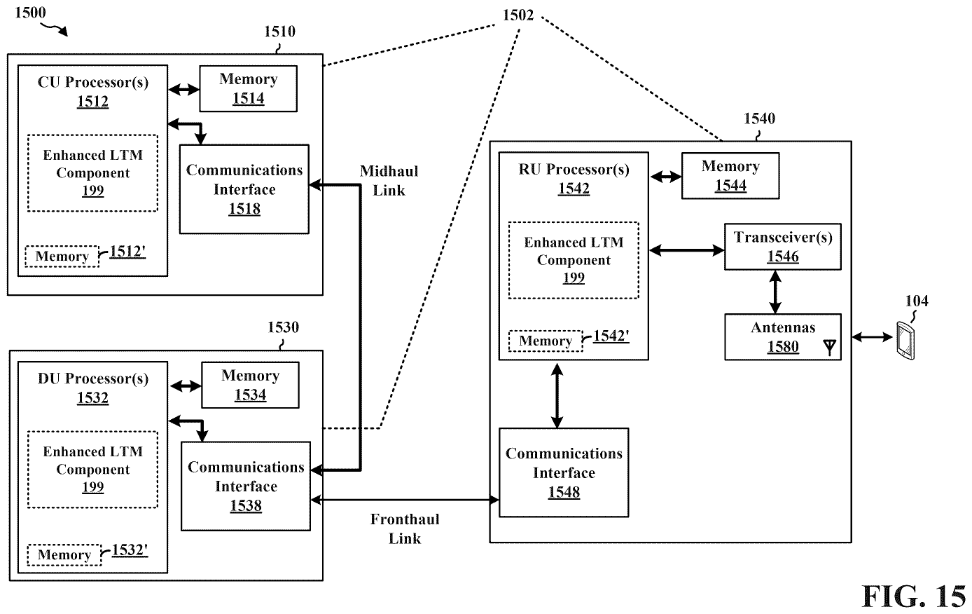

At 1008, the base station may transmit, to a UE, a cell switch command associated with a first cell switch operation. For example, 1004 may be performed by CU processor(s) 1512, DU processor(s) 1532, RU processor(s) 1542, transceiver(s) 1546, antenna(s) 1580, and/or enhanced LTM component 199 of FIG. 15. In some aspects, the cell switch command may be associated with one of: a LTM, a conditional LTM, a L3 handover, or a conditional L3 handover. For example, referring to FIG. 4, the UE 404 may receive, and the base station 402 may transmit, the CSC 418.

At 1018, the base station may receive, from the UE, an indication of an override of the cell switch command based on a cell switch preemption capability of the UE. For example, 1004 may be performed by CU processor(s) 1512, DU processor(s) 1532, RU processor(s) 1542, transceiver(s) 1546, antenna(s) 1580, and/or enhanced LTM component 199 of FIG. 15. In some aspects, the indication may be received from the UE (a direct transmission) or from the UE via a target cell for a non-indicated cell switch triggered by the cell switch command (to be provided to the first cell by the target cell as part of an indirect transmission from the UE to the first cell). The indication, in some aspects, may be an indication relating to the override of the cell switch command, and the indication may relate to one or more of a reason for the override of the cell switch command, an action taken instead of performing the first cell switch operation, a candidate target cell, a candidate target group of cells, metrics for listed candidate cells, a metric for an indicated target cell in the cell switch command. In some aspects, the indication may further indicate an overridden value that is one or more of for one or more parameters associated with the cell switch command, where the one or more parameters relate to one or more of a first target cell indicated in the cell switch command, whether to perform a RACH based cell switch, an index of a SSB, a TCI (or TCI state ID), or a TA value. For example, referring to FIG. 4, the UE 404 may receive, and the base station 402 may transmit, the action report 424 or the action report 430.

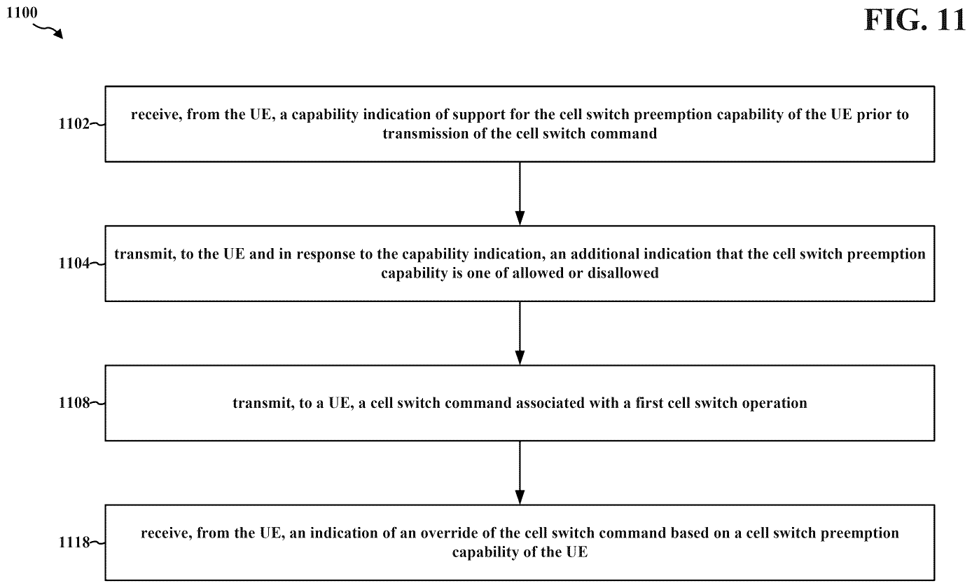

FIG. 11 is a flowchart 1100 of a method of wireless communication. The method may be performed by a network device such as a base station (e.g., the base station 102, 402, 502; the network entity 1402, 1502). At 1102, the base station may receive, from the UE, a capability indication of support for the cell switch preemption capability of the UE prior to transmission of the cell switch command. For example, 1102 may be performed by CU processor(s) 1512, DU processor(s) 1532, RU processor(s) 1542, transceiver(s) 1546, antenna(s) 1580, and/or enhanced LTM component 199 of FIG. 15. In some aspects, the indication of support for the cell switch preemption capability, may be received in UE capability information. For example, referring to FIG. 4, the UE 404 may transmit, and the base station 402 may receive, the preemption capability indication 414.

At 1104, the base station may transmit, to the UE and in response to the capability indication, an additional indication that the cell switch preemption capability is one of allowed or disallowed. For example, 1104 may be performed by CU processor(s) 1512, DU processor(s) 1532, RU processor(s) 1542, transceiver(s) 1546, antenna(s) 1580, and/or enhanced LTM component 199 of FIG. 15. In some aspects, the additional indication may be included in a RRC message and applies to one of LTM for the UE or one or more groups of one or more LTM candidate cells. The additional indication, in some aspects, may be included in one of DCI, a MAC-CE, or a LTM cell switch command (e.g., a LTM CSC to which it applies). For example, referring to FIG. 4, the UE 404 may receive, and the base station 402 may transmit, the preemption configurations 416.

At 1108, the base station may transmit, to a UE, a cell switch command associated with a first cell switch operation. For example, 1108 may be performed by CU processor(s) 1512, DU processor(s) 1532, RU processor(s) 1542, transceiver(s) 1546, antenna(s) 1580, and/or enhanced LTM component 199 of FIG. 15. In some aspects, the cell switch command may be associated with one of: a LTM, a conditional LTM, a L3 handover, or a conditional L3 handover. For example, referring to FIG. 4, the UE 404 may receive, and the base station 402 may transmit, the CSC 418.

At 1118, the base station may receive, from the UE, an indication of an override of the cell switch command based on a cell switch preemption capability of the UE. For example, 1118 may be performed by CU processor(s) 1512, DU processor(s) 1532, RU processor(s) 1542, transceiver(s) 1546, antenna(s) 1580, and/or enhanced LTM component 199 of FIG. 15. In some aspects, the indication may be received from the UE (a direct transmission) or from the UE via a target cell for a non-indicated cell switch triggered by the cell switch command (to be provided to the first cell by the target cell as part of an indirect transmission from the UE to the first cell). The indication, in some aspects, may be an indication relating to the override of the cell switch command, and the indication may relate to one or more of a reason for the override of the cell switch command, an action taken instead of performing the first cell switch operation, a candidate target cell, a candidate target group of cells, metrics for listed candidate cells, a metric for an indicated target cell in the cell switch command. In some aspects, the indication may further indicate an overridden value that is one or more of for one or more parameters associated with the cell switch command, where the one or more parameters relate to one or more of a first target cell indicated in the cell switch command, whether to perform a RACH based cell switch, an index of a SSB, a TCI (or TCI state ID), or a TA value. For example, referring to FIG. 4, the UE 404 may receive, and the base station 402 may transmit, the action report 424 or the action report 430.

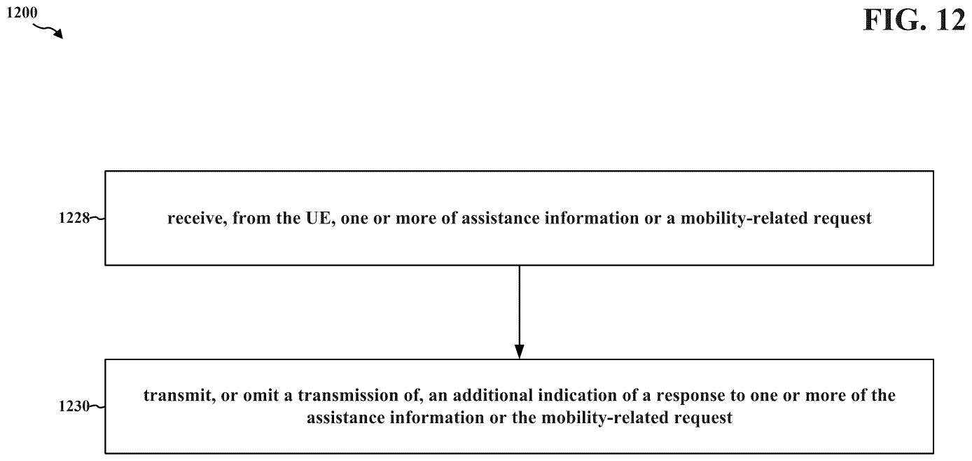

FIG. 12 is a flowchart 1200 of a method of wireless communication. The method may be performed by a network device such as a base station (e.g., the base station 102, 402, 502; the network entity 1402, 1502). In some aspects, the base station may receive, from the UE, a second indication of whether the UE supports a transmission of at least one of the assistance information or the mobility-related request. The indication of whether the UE supports a transmission of at least one of assistance information or a mobility-related request, in some aspects, may be received in UE capability information. For example, referring to FIG. 5, the UE 504 may transmit, and the base station 502 may receive, the one or more UE capability indications 513.

In some aspects, the base station may receive, from the UE, a third indication of one or more functionalities associated with the UE supporting the transmission of at least one of the assistance information or the mobility-related request. In some aspects, the additional indication may be included in UE assistance information. For example, referring to FIG. 5, the UE 504 may transmit, and the base station 502 may receive, the one or more UE capability indications 513.

At 1228, the base station may receive, from the UE, one or more of assistance information or a mobility-related request. For example, 1228 may be performed by CU processor(s) 1512, DU processor(s) 1532, RU processor(s) 1542, transceiver(s) 1546, antenna(s) 1580, and/or enhanced LTM component 199 of FIG. 15. One or more of the assistance information or the mobility-related request may be based on mobility-related information collected by the UE which, in some aspects, may include one or more of a channel measurement history associated with one or more cells, a cell search history, a cell switch history, one or more key performance indicators associated with the cell search history, dual connection statistics, an internal condition of the UE, or one or more AI/ML predictions. In some aspects, the mobility-related information may be used to determine whether, or how, to override one or more values for one or more parameters associated with a CSC. In some aspects, one or more of the assistance information or the mobility-related request may include one or more of a first indication of a first set of candidate target cells for a LTM operation, a second indication of a second set of candidate target cells for a conditional LTM operation, a first request to update a current set of candidate target cells for the cell switch command, a second request to activate a transmission configuration indicator for a first candidate target cell, a third request for an early uplink random access channel synchronization, or a fourth request to initiate a LTM operation. One or more of the assistance information or the mobility-related request, in some aspects, may be associated with an indication of a reason for transmitting one or more of the assistance information or the mobility-related request, where the reason relates to one or more of: a first quality of a first signal from the first cell being less than a first threshold quality, a second quality of a second signal from at least one candidate target cell being greater than a second threshold quality, a first identification of a first set of cells that are better candidate target cells than at least a first candidate target cell in a current set of candidate target cells, a second identification of a second set of candidate target cells in the current set of candidate target cells that do not meet one or more criteria for being included in the current set of candidate target cells, a third identification of one or more TCIs that are better TCIs than one or more current TCIs, or a fourth identification of one or more activated TCIs that are associated with a third quality that is below a third threshold quality. In some aspects, one or more of the assistance information or the mobility-related request may be associated with an indication of an action to be performed by the UE if the UE fails to receive a response to one or more of the assistance information or the mobility-related request within a response window, and the UE is configured with a conditional LTM configuration associated with a set of candidate target cells and a corresponding set of beams, and where the action includes one or more of: a first conditional LTM cell switch operation based on the conditional LTM configuration towards a first candidate target cell in the set of candidate target cells and a corresponding beam selected by the UE that is not a first target cell indicated in the cell switch command, or a TCI state activation with a second candidate target cell in the set of candidate target cells and a beam selected by the UE. For example, referring to FIG. 5, the UE 504 may transmit, and the base station 502 may receive, one of message 514 or request 522.

At 1230, the base station may transmit, or omit a transmission of, an additional indication of a response to one or more of the assistance information or the mobility-related request. The response, in some aspects, may include one or more of an acceptance of one or more of the assistance information or the mobility-related request, a rejection of one or more of the assistance information or the mobility-related request, or an alternative to one or more of the assistance information or the mobility-related request. In some aspects, receiving the indication at 1230 may include one of: transmitting, at 1231, one of DCI or a MAC-CE indicating the response of the first cell, or refraining, at 1233, from transmitting an explicit indication during a response window, where the refrainment from the transmission of the explicit indication (e.g., a failure to transmit the explicit indication) indicates the acceptance of one or more of the assistance information or the mobility-related request. For example, 1230, 1231, and 1233 may be performed by CU processor(s) 1512, DU processor(s) 1532, RU processor(s) 1542, transceiver(s) 1546, antenna(s) 1580, and/or enhanced LTM component 199 of FIG. 15. In some aspects, a failure to receive an explicit indication further indicates for the UE to autonomously determine whether to take an action associated with one or more of the assistance information or the mobility-related request. For example, referring to FIG. 5, the UE 504 may receive, and the base station 502 may transmit, the response 516B or the response 524B or may fail to receive a response based on the omitting at 516A or 524A.

In some aspects, the UE may receive an additional indication of the action performed by the UE. The additional indication may be transmitted to the first cell (if no cell switch has been performed) or to a target cell for forwarding to the first cell (if a cell switch to the target cell has been performed). For example, referring to FIG. 5, the UE 504 may transmit, and the base station 502 may receive, an action report in the set of additional signals 518 (or the forwarded action report 530) or the UE 504 may transmit, and the base station 508 may receive, the action report 528.

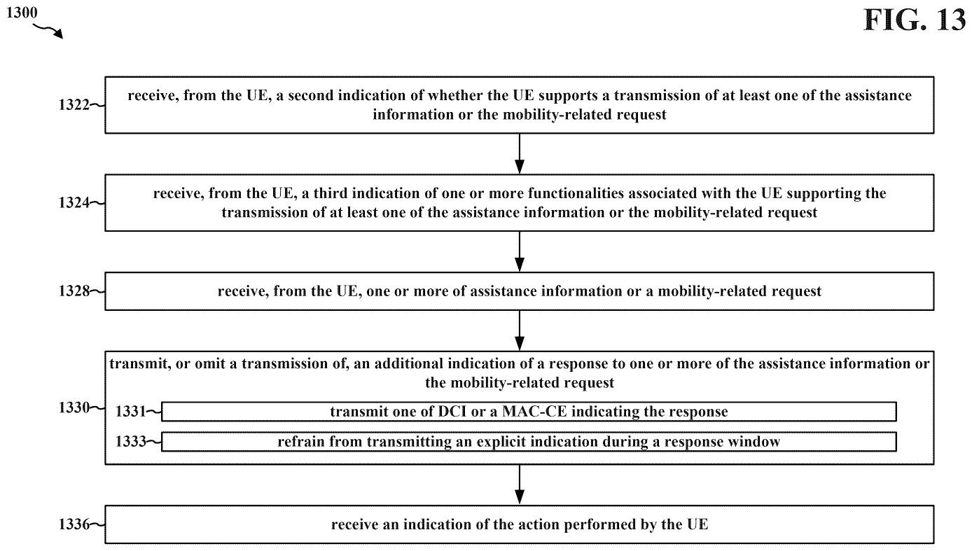

FIG. 13 is a flowchart 1300 of a method of wireless communication. The method may be performed by a network device such as a base station (e.g., the base station 102, 402, 502; the network entity 1402, 1502). At 1322, the base station may receive, from the UE, a second indication of whether the UE supports a transmission of at least one of the assistance information or the mobility-related request. For example, 1322 may be performed by CU processor(s) 1512, DU processor(s) 1532, RU processor(s) 1542, transceiver(s) 1546, antenna(s) 1580, and/or enhanced LTM component 199 of FIG. 15. In some aspects, the indication of whether the UE supports a transmission of at least one of assistance information or a mobility-related request may be received in UE capability information. For example, referring to FIG. 5, the UE 504 may transmit, and the base station 502 may receive, the one or more UE capability indications 513.

At 1324, the base station may receive, from the UE, a third indication of one or more functionalities associated with the UE supporting the transmission of at least one of the assistance information or the mobility-related request. For example, 1324 may be performed by CU processor(s) 1512, DU processor(s) 1532, RU processor(s) 1542, transceiver(s) 1546, antenna(s) 1580, and/or enhanced LTM component 199 of FIG. 15. In some aspects, the additional indication may be included in UE assistance information. For example, referring to FIG. 5, the UE 504 may transmit, and the base station 502 may receive, the one or more UE capability indications 513.

At 1328, the base station may receive, from the UE, one or more of assistance information or a mobility-related request. For example, 1328 may be performed by CU processor(s) 1512, DU processor(s) 1532, RU processor(s) 1542, transceiver(s) 1546, antenna(s) 1580, and/or enhanced LTM component 199 of FIG. 15. One or more of the assistance information or the mobility-related request may be based on mobility-related information collected by the UE which, in some aspects, may include one or more of a channel measurement history associated with one or more cells, a cell search history, a cell switch history, one or more key performance indicators associated with the cell search history, dual connection statistics, an internal condition of the UE, or one or more AI/ML predictions. In some aspects, the mobility-related information may be used to determine whether, or how, to override one or more values for one or more parameters associated with a CSC. In some aspects, one or more of the assistance information or the mobility-related request may include one or more of a first indication of a first set of candidate target cells for a LTM operation, a second indication of a second set of candidate target cells for a conditional LTM operation, a first request to update a current set of candidate target cells for the cell switch command, a second request to activate a transmission configuration indicator for a first candidate target cell, a third request for an early uplink random access channel synchronization, or a fourth request to initiate a LTM operation. One or more of the assistance information or the mobility-related request, in some aspects, may be associated with an indication of a reason for transmitting one or more of the assistance information or the mobility-related request, where the reason relates to one or more of: a first quality of a first signal from the first cell being less than a first threshold quality, a second quality of a second signal from at least one candidate target cell being greater than a second threshold quality, a first identification of a first set of cells that are better candidate target cells than at least a first candidate target cell in a current set of candidate target cells, a second identification of a second set of candidate target cells in the current set of candidate target cells that do not meet one or more criteria for being included in the current set of candidate target cells, a third identification of one or more TCIs that are better TCIs than one or more current TCIs, or a fourth identification of one or more activated TCIs that are associated with a third quality that is below a third threshold quality. In some aspects, one or more of the assistance information or the mobility-related request may be associated with an indication of an action to be performed by the UE if the UE fails to receive a response to one or more of the assistance information or the mobility-related request within a response window, and the UE is configured with a conditional LTM configuration associated with a set of candidate target cells and a corresponding set of beams, and where the action includes one or more of: a first conditional LTM cell switch operation based on the conditional LTM configuration towards a first candidate target cell in the set of candidate target cells and a corresponding beam selected by the UE that is not a first target cell indicated in the cell switch command, or a TCI state activation with a second candidate target cell in the set of candidate target cells and a beam selected by the UE. For example, referring to FIG. 5, the UE 504 may transmit, and the base station 502 may receive, one of message 514 or request 522.

At 1330, the base station may transmit, or omit a transmission of, an additional indication of a response to one or more of the assistance information or the mobility-related request. The response, in some aspects, may include one or more of an acceptance of one or more of the assistance information or the mobility-related request, a rejection of one or more of the assistance information or the mobility-related request, or an alternative to one or more of the assistance information or the mobility-related request. In some aspects, receiving the indication at 1330 may include one of: transmitting, at 1331, one of DCI or a MAC-CE indicating the response of the first cell, or refraining, at 1333, from transmitting an explicit indication during a response window, where the refrainment from the transmission of the explicit indication (e.g., a failure to transmit the explicit indication) indicates the acceptance of one or more of the assistance information or the mobility-related request. For example, 1330, 1331, and 1333 may be performed by CU processor(s) 1512, DU processor(s) 1532, RU processor(s) 1542, transceiver(s) 1546, antenna(s) 1580, and/or enhanced LTM component 199 of FIG. 15. In some aspects, a failure to receive an explicit indication further indicates for the UE to autonomously determine whether to take an action associated with one or more of the assistance information or the mobility-related request. For example, referring to FIG. 5, the UE 504 may receive, and the base station 502 may transmit, the response 516B or the response 524B or may fail to receive a response based on the omitting at 516A or 524A.

At 1336, the UE may receive an additional indication of the action performed by the UE. For example, 1336 may be performed by CU processor(s) 1512, DU processor(s) 1532, RU processor(s) 1542, transceiver(s) 1546, antenna(s) 1580, and/or enhanced LTM component 199 of FIG. 15. The additional indication may be transmitted to the first cell (if no cell switch has been performed) or to a target cell for forwarding to the first cell (if a cell switch to the target cell has been performed). For example, referring to FIG. 5, the UE 504 may transmit, and the base station 502 may receive, an action report in the set of additional signals 518 (or the forwarded action report 530) or the UE 504 may transmit, and the base station 508 may receive, the action report 528.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize one or more antennas 1480 for communication. The cellular baseband processor(s) 1424 communicates through the transceiver(s) 1422 via the one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the enhanced LTM component 198 may be configured to receive, from a first cell, a cell switch command associated with a first cell switch operation and override the cell switch command based on a cell switch preemption capability of the UE. In some aspects, the enhanced LTM component 198 may be configured to obtain mobility-related information and transmit, to a first cell and based on the mobility-related information, one or more of assistance information or a mobility-related request. The enhanced LTM component 198 may be within the cellular baseband processor(s) 1424, the application processor(s) 1406, or both the cellular baseband processor(s) 1424 and the application processor(s) 1406. The enhanced LTM component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for receiving, from a first cell, a cell switch command associated with a first cell switch operation. The apparatus 1404, and in particular the cellular baseband processor(s) 1424 and/or the application processor(s) 1406, may include means for overriding the cell switch command based on a cell switch preemption capability of the UE. The apparatus 1404, and in particular the cellular baseband processor(s) 1424 and/or the application processor(s) 1406, may include means for refraining from performing the first cell switch operation associated with the cell switch command. The apparatus 1404, and in particular the cellular baseband processor(s) 1424 and/or the application processor(s) 1406, may include means for overriding one or more values for one or more parameters associated with the cell switch command. The apparatus 1404, and in particular the cellular baseband processor(s) 1424 and/or the application processor(s) 1406, may include means for performing a second cell switch operation to a UE-selected target cell that is different from the first target cell indicated in the cell switch command. The apparatus 1404, and in particular the cellular baseband processor(s) 1424 and/or the application processor(s) 1406, may include means for refraining from performing the first cell switch operation associated with the L3 handover and performing the second cell switch operation associated with the conditional LTM. The apparatus 1404, and in particular the cellular baseband processor(s) 1424 and/or the application processor(s) 1406, may include means for refraining from performing the first cell switch operation associated with the LTM and performing the second cell switch operation associated with one of the conditional LTM or the conditional L3 handover. The apparatus 1404, and in particular the cellular baseband processor(s) 1424 and/or the application processor(s) 1406, may include means for transmitting, to the first cell, an indication of support for the cell switch preemption capability prior to the reception of the cell switch command. The apparatus 1404, and in particular the cellular baseband processor(s) 1424 and/or the application processor(s) 1406, may include means for receiving, from the first cell, an additional indication that the cell switch preemption capability is one of allowed or disallowed by the first cell. The apparatus 1404, and in particular the cellular baseband processor(s) 1424 and/or the application processor(s) 1406, may include means for transmitting, to one of the first cell or a target cell for a non-indicated cell switch, an indication relating to the override of the cell switch command. The apparatus 1404, and in particular the cellular baseband processor(s) 1424 and/or the application processor(s) 1406, may include means for obtaining mobility-related information. The apparatus 1404, and in particular the cellular baseband processor(s) 1424 and/or the application processor(s) 1406, may include means for transmitting, to the first cell and based on the mobility-related information, one or more of assistance information or a mobility-related request. The apparatus 1404, and in particular the cellular baseband processor(s) 1424 and/or the application processor(s) 1406, may include means for receiving, from the first cell, an indication of a response of the first cell to one or more of the assistance information or the mobility-related request. The apparatus 1404, and in particular the cellular baseband processor(s) 1424 and/or the application processor(s) 1406, may include means for receiving one of downlink control information (DCI) or a medium access control (MAC) control element (CE) (MAC-CE) indicating the response of the first cell. The apparatus 1404, and in particular the cellular baseband processor(s) 1424 and/or the application processor(s) 1406, may include means for failing to receive an explicit indication during a response window. The apparatus 1404, and in particular the cellular baseband processor(s) 1424 and/or the application processor(s) 1406, may include means for performing the action associated with one or more of the assistance information or the mobility-related request. The apparatus 1404, and in particular the cellular baseband processor(s) 1424 and/or the application processor(s) 1406, may include means for transmitting an additional indication of the action performed by the UE. The apparatus 1404, and in particular the cellular baseband processor(s) 1424 and/or the application processor(s) 1406, may include means for transmitting, to the first cell, an indication of whether the UE supports a transmission of at least one of the assistance information or the mobility-related request. The apparatus 1404, and in particular the cellular baseband processor(s) 1424 and/or the application processor(s) 1406, may include means for transmitting, to the first cell, an additional indication of one or more functionalities associated with at least one of the assistance information or the mobility-related request supported by the UE. The apparatus 1404, and in particular the cellular baseband processor(s) 1424 and/or the application processor(s) 1406, may include means for transmitting, to the first cell, an indication of the override of the cell switch command based on the cell switch preemption capability of the UE. The apparatus 1404 may further include means for performing any of the aspects described in connection with the flowcharts in FIGS. 6-9, and/or performed by the UE in the communication flow of FIGS. 4 and 5. The means may be the enhanced LTM component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the enhanced LTM component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, one or more antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the enhanced LTM component 199 may be configured to transmit, to a UE, a cell switch command associated with a first cell switch operation and receive, from the UE, an indication of an override of the cell switch command based on a cell switch preemption capability of the UE. In some aspects, the enhanced LTM component 199 may be configured to receive, from the UE, one or more of assistance information or a mobility-related request and transmit, or omit a transmission of, an additional indication of a response to one or more of the assistance information or the mobility-related request. The enhanced LTM component 199 may be within one or more processors of one or more of the CU 1510, DU 1530, and the RU 1540. The enhanced LTM component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for transmitting, to a user equipment (UE), a cell switch command associated with a first cell switch operation. The network entity 1502, in some aspects, may include means for receiving, from the UE, an indication of an override of the cell switch command based on a cell switch preemption capability of the UE. The network entity 1502, in some aspects, may include means for receiving, from the UE, a capability indication of support for the cell switch preemption capability of the UE prior to transmission of the cell switch command. The network entity 1502, in some aspects, may include means for transmitting, to the UE and in response to the capability indication, an additional indication that the cell switch preemption capability is one of allowed or disallowed. The network entity 1502, in some aspects, may include means for receiving, from one or more of the UE or a target cell for a cell switch triggered by the cell switch command, information relating to the indication of the override of the cell switch command. The network entity 1502, in some aspects, may include means for receiving, from the UE, one or more of assistance information or a mobility-related request. The network entity 1502, in some aspects, may include means for transmitting, or omitting a transmission of, an additional indication of a response to one or more of the assistance information or the mobility-related request. The network entity 1502, in some aspects, may include means for transmitting one of downlink control information (DCI) or a medium access control (MAC) control element (CE) (MAC-CE) indicating the response to one or more of the assistance information or the mobility-related request. The network entity 1502, in some aspects, may include means for refraining from transmitting an explicit indication during a response window. The network entity 1502, in some aspects, may include means for receiving, from the UE, a second indication of whether the UE supports a transmission of at least one of the assistance information or the mobility-related request. The network entity 1502, in some aspects, may include means for receiving, from the UE, a third indication of one or more functionalities associated with the UE supporting the transmission of at least one of the assistance information or the mobility-related request. The network entity 1502 may further include means for performing any of the aspects described in connection with the flowchart in FIGS. 10-13, and/or performed by the base station in the communication flow of FIGS. 4 and 5. The means may be the enhanced LTM component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to LTM enhancements. The LTM enhancements, in some aspects, may include, or relate to, one or more of a UE assisted LTM enhancement scheme which includes a UE providing an assistance information message and/or a request message, an action by a base station in response to the UE's assistance information message and/or the request message, and/or a UE's autonomous action and report (e.g., which may depend on a base station's response to the assistance information message and/or the request message transmitted by a UE). In some aspects, the LTM enhancements may include, or relate to, allowing the UE to ignore a CSC from the network and override the CSC or perform a different cell switch operation (e.g., a CHO or C-LTM). Allowing the UE to ignore a CSC may be associated with autonomous UE operation during an LTM cell switching procedure for overriding (e.g., preempting or modifying) the LTM behavior upon receiving the LTM CSC based on UE local information. In some examples, a wireless device may be configured to receive, from a first cell, a cell switch command associated with a first cell switch operation and override the cell switch command based on a cell switch preemption capability of the UE. In some examples, a network device may be configured to transmit, to a UE, a cell switch command associated with a first cell switch operation and receive, from the UE, an indication of an override of the cell switch command based on a cell switch preemption capability of the UE. In some examples, a wireless device may be configured to obtain mobility-related information and transmit, to a first cell and based on the mobility-related information, one or more of assistance information or a mobility-related request. In some examples, a network device may be configured to receive, from the UE, one or more of assistance information or a mobility-related request and transmit, or omit a transmission of, an additional indication of a response to one or more of the assistance information or the mobility-related request.

Particular aspects of the subject matter described in this disclosure can be implemented to realize one or more of the following potential advantages. In some examples, by the LTM enhancements related to allowing preemption of a CSC and/or providing an assistance information message and/or a request message, the described techniques can be used to improve mobility operations.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a first cell, a cell switch command associated with a first cell switch operation; and overriding the cell switch command based on a cell switch preemption capability of the UE.

Aspect 2 is the method of aspect 1, wherein overriding the cell switch command based on the cell switch preemption capability of the UE comprises one or more of: refraining from performing the first cell switch operation associated with the cell switch command; overriding one or more values for one or more parameters associated with the cell switch command, wherein the one or more parameters relate to one or more of a first target cell indicated in the cell switch command, whether to perform a random access channel (RACH) based cell switch, an index of a synchronization signal block (SSB), a transmission configuration indicator, or a timing advance value; or performing a second cell switch operation to a UE-selected target cell that is different from the first target cell indicated in the cell switch command, wherein the second cell switch operation is not indicated in the cell switch command.

Aspect 3 is the method of aspect 2, wherein the cell switch command is associated with one of: a lower-layer triggered mobility (LTM); a conditional LTM; a layer 3 (L3) handover; or a conditional L3 handover.

Aspect 4 is the method of aspect 3, wherein overriding the cell switch command based on the cell switch preemption capability of the UE comprises one of: refraining from performing the first cell switch operation associated with the L3 handover and performing the second cell switch operation associated with the conditional LTM; or refraining from performing the first cell switch operation associated with the LTM and performing the second cell switch operation associated with one of the conditional LTM or the conditional L3 handover.

Aspect 5 is the method of any of aspects 1 to 4, further comprising: transmitting, to the first cell, an indication of support for the cell switch preemption capability prior to the reception of the cell switch command.

Aspect 6 is the method of aspect 5, further comprising: receiving, from the first cell, an additional indication that the cell switch preemption capability is one of allowed or disallowed by the first cell.

Aspect 7 is the method of aspect 6, wherein the additional indication is included in a radio resource control (RRC) message and applies to one of: lower-layer triggered mobility (LTM) for the UE; or one or more groups of one or more LTM candidate cells.

Aspect 8 is the method of aspect 6, wherein the additional indication is included in one of downlink control information (DCI), a medium access control (MAC) control element (CE) (MAC-CE), or a lower-layer triggered mobility (LTM) cell switch command.

Aspect 9 is the method of any of aspects 1 to 8, further comprising: transmitting, to one of the first cell or a target cell for a non-indicated cell switch, an indication relating to the override of the cell switch command, wherein the indication relates to one or more of a reason for the override of the cell switch command, an action taken instead of performing the first cell switch operation, a candidate target cell, a candidate target group of cells, metrics for listed candidate cells, a metric for an indicated target cell in the cell switch command.

Aspect 10 is the method of any of aspects 1 to 9, further comprising: obtaining mobility-related information, wherein the override of the cell switch command is based on the mobility-related information and the mobility-related information comprises one or more of a channel measurement history associated with one or more cells, a cell search history, a cell switch history, one or more key performance indicators associated with the cell search history, dual connection statistics, an internal condition of the UE, or one or more artificial intelligence (AI)/machine learning (ML) predictions.

Aspect 11 is the method of any of aspects 1 to 10, further comprising: obtaining mobility-related information, wherein the mobility-related information comprises one or more of a channel measurement history associated with one or more cells, a cell search history, a cell switch history, one or more key performance indicators associated with the cell search history, dual connection statistics, an internal condition of the UE, or one or more artificial intelligence (AI)/machine learning (ML) predictions; and transmitting, to the first cell and based on the mobility-related information, one or more of assistance information or a mobility-related request. Aspect 12 is the method of aspect 11, wherein one or more of the assistance information or the mobility-related request comprises one or more of: a first indication of a first set of candidate target cells for a lower-layer triggered mobility (LTM) operation, a second indication of a second set of candidate target cells for a conditional LTM operation, a first request to update a current set of candidate target cells for the cell switch command, a second request to activate a transmission configuration indicator for a first candidate target cell, a third request for an early uplink random access channel synchronization, or a fourth request to initiate a LTM operation.

Aspect 13 is the method of any of aspects 11 and 12, wherein one or more of the assistance information or the mobility-related request is associated with an indication of a reason for transmitting one or more of the assistance information or the mobility-related request, wherein the reason relates to one or more of: a first quality of a first signal from the first cell being less than a first threshold quality, a second quality of a second signal from at least one candidate target cell being greater than a second threshold quality, a first identification of a first set of cells that are better candidate target cells than at least a first candidate target cell in a current set of candidate target cells, a second identification of a second set of candidate target cells in the current set of candidate target cells that do not meet one or more criteria for being included in the current set of candidate target cells, a third identification of one or more transmission configuration indicators (TCIs) that are better TCIs than one or more current TCIs, or a fourth identification of one or more activated TCIs that are associated with a third quality that is below a third threshold quality.

Aspect 14 is the method of any of aspects 11 to 13, wherein one or more of the assistance information or the mobility-related request is associated with an indication of an action to be performed by the UE if the UE fails to receive a response to one or more of the assistance information or the mobility-related request within a response window, wherein the UE is configured with a conditional LTM configuration associated with a set of candidate target cells and a corresponding set of beams, and wherein the action comprises one or more of: a first conditional LTM cell switch operation based on the conditional LTM configuration towards a first candidate target cell in the set of candidate target cells and a corresponding beam selected by the UE that is not a first target cell indicated in the cell switch command, or a TCI state activation with a second candidate target cell in the set of candidate target cells and a beam selected by the UE.

Aspect 15 is the method of any of aspects 11 to 14, further comprising: receiving, from the first cell, an indication of a response of the first cell to one or more of the assistance information or the mobility-related request, wherein the response comprises one or more of an acceptance of one or more of the assistance information or the mobility-related request, a rejection of one or more of the assistance information or the mobility-related request, or an alternative to one or more of the assistance information or the mobility-related request.

Aspect 16 is the method of aspect 15, wherein receiving the indication comprises one of: receiving one of downlink control information (DCI) or a medium access control (MAC) control element (CE) (MAC-CE) indicating the response of the first cell; or failing to receive an explicit indication during a response window, wherein failure to receive the explicit indication indicates the acceptance of one or more of the assistance information or the mobility-related request.

Aspect 17 is the method of aspect 16, wherein the failure to receive the explicit indication further indicates for the UE to autonomously determine whether to take an action associated with one or more of the assistance information or the mobility-related request, the method further comprising: performing the action associated with one or more of the assistance information or the mobility-related request; and transmitting an additional indication of the action performed by the UE.

Aspect 18 is the method of any of aspects 11 to 17, further comprising one or more of: transmitting, to the first cell, an indication of whether the UE supports a transmission of at least one of the assistance information or the mobility-related request; or transmitting, to the first cell, an additional indication of one or more functionalities associated with at least one of the assistance information or the mobility-related request supported by the UE.

Aspect 19 is the method of any of aspects 1 to 18, further comprising: transmitting, to the first cell, an indication of the override of the cell switch command based on the cell switch preemption capability of the UE.

Aspect 20 is a method of wireless communication at a network device, comprising: transmitting, to a user equipment (UE), a cell switch command associated with a first cell switch operation; and receiving, from the UE, an indication of an override of the cell switch command based on a cell switch preemption capability of the UE. Aspect 21 is the method of aspect 20, further comprising: receiving, from the UE, a capability indication of support for the cell switch preemption capability of the UE prior to transmission of the cell switch command.

Aspect 22 is the method of aspect 21, further comprising: transmitting, to the UE and in response to the capability indication, an additional indication that the cell switch preemption capability is one of allowed or disallowed.

Aspect 23 is the method of aspect 22, wherein the additional indication is included in a radio resource control (RRC) message and applies to one of: lower-layer triggered mobility (LTM) for the UE; or one or more groups of one or more LTM candidate cells.

Aspect 24 is the method of aspect 22, wherein the additional indication is included in one of downlink control information (DCI), a medium access control (MAC) control element (CE) (MAC-CE), or a lower-layer triggered mobility (LTM) cell switch command.

Aspect 25 is the method of any of aspects 20 to 24, further comprising: receiving, from one or more of the UE or a target cell for a cell switch triggered by the cell switch command, information relating to the indication of the override of the cell switch command, wherein the information relates to one or more of a reason that the cell switch command was overridden by the UE, an action taken instead of following the cell switch command, a candidate target cell, a candidate target group of cells, metrics for listed candidate cells, a metric for an indicated target cell in the cell switch command.

Aspect 26 is the method of any of aspects 20 to 25, wherein the cell switch command is associated with one of: a lower-layer triggered mobility (LTM); a conditional LTM; a layer 3 (L3) handover; or a conditional L3 handover.

Aspect 27 is the method of any of aspects 20 to 26, further comprising: receiving, from the UE, one or more of assistance information or a mobility-related request.

Aspect 28 is the method of aspect 27, wherein one or more of the assistance information or the mobility-related request comprises one or more of: a first indication of a first set of candidate target cells for a lower-layer triggered mobility (LTM) operation, a second indication of a second set of candidate target cells for a conditional LTM operation, a first request to update a current set of candidate target cells for the cell switch command, a second request to activate a transmission configuration index for a first candidate target cell, a third request for an early uplink random access channel synchronization, or a fourth request to initiate a LTM operation. Aspect 29 is the method of any of aspects 27 and 28, wherein one or more of the assistance information or the mobility-related request is associated with an additional indication of a reason for transmitting one or more of the assistance information or the mobility-related request, wherein the reason relates to one or more of: a first quality of a first signal from a first cell of the network device being less than a first threshold quality, a second quality of a second signal from at least one candidate target cell being greater than a second threshold quality, a first identification of a first set of cells that are better candidate target cells than at least a first candidate target cell in a current set of candidate target cells, a second identification of a second set of candidate target cells in the current set of candidate target cells that do not meet one or more criteria for being included in the current set of candidate target cells, a third identification of one or more transmission configuration indexes (TCIs) that are better TCIs than one or more current TCIs, or a fourth identification of one or more activated TCIs that are associated with a third quality that is below a third threshold quality.

Aspect 30 is the method of any of aspects 27 to 29, further comprising: transmitting, or omitting a transmission of, an additional indication of a response to one or more of the assistance information or the mobility-related request, wherein the response comprises one or more of an acceptance of one or more of the assistance information or the mobility-related request, a rejection of one or more of the assistance information or the mobility-related request, or an alternative to one or more of the assistance information or the mobility-related request.

Aspect 31 is the method of aspect 30, wherein receiving the additional indication comprises one of: transmitting one of downlink control information (DCI) or a medium access control (MAC) control element (CE) (MAC-CE) indicating the response to one or more of the assistance information or the mobility-related request; or refraining from transmitting an explicit indication during a response window, wherein the refrainment from the transmission of the explicit indication indicates the acceptance of one or more of the assistance information or the mobility-related request.

Aspect 32 is the method of aspect 31, wherein the refrainment from the transmission of the explicit indication further indicates for the UE to autonomously determine whether to take an action associated with one or more of the assistance information or the mobility-related request.

Aspect 33 is the method of any of aspects 27 to 32, further comprising one or more of: receiving, from the UE, a second indication of whether the UE supports a transmission of at least one of the assistance information or the mobility-related request; or receiving, from the UE, a third indication of one or more functionalities associated with the UE supporting the transmission of at least one of the assistance information or the mobility-related request.

Aspect 34 is a method of wireless communication at a user equipment (UE), comprising: obtaining mobility-related information; and transmitting, to a first cell and based on the mobility-related information, one or more of assistance information or a mobility-related request.

Aspect 35 is a method of wireless communication at a network device, comprising: receiving, from the UE, one or more of assistance information or a mobility-related request; and transmitting, or omitting a transmission of, an additional indication of a response to one or more of the assistance information or the mobility-related request.

Aspect 36 is an apparatus for wireless communication at a UE, comprising: at least one memory; and at least one processor coupled to the at least one memory, the at least one processor is configured to perform the method of any of aspects 1 to 19 or 34.

Aspect 37 is an apparatus for wireless communication at a UE, comprising means for performing each step in the method of any of aspects 1 to 19 or 34.

Aspect 38 is the apparatus of any of aspects 36 to 37, further comprising a transceiver configured to receive or to transmit in association with the method of any of aspects 1 to 19 or 34.

Aspect 39 is a computer-readable medium (e.g., a non-transitory computer-readable medium) storing computer executable code at a UE, the code when executed by at least one processor causes the at least one processor to perform the method of any of aspects 1 to 19 or 34.

Aspect 40 is an apparatus for wireless communication at a network device, comprising: at least one memory; and at least one processor coupled to the at least one memory, the at least one processor is configured to perform the method of any of aspects 20 to 33 or 35.

Aspect 41 is an apparatus for wireless communication at a network device, comprising means for performing each step in the method of any of aspects 20 to 33 or 35.

Aspect 42 is the apparatus of any of aspects 40 to 41, further comprising a transceiver configured to receive or to transmit in association with the method of any of aspects 20 to 33 or 35.

Aspect 43 is a computer-readable medium (e.g., a non-transitory computer-readable medium) storing computer executable code at a network device, the code when executed by at least one processor causes the at least one processor to perform the method of any of aspects 20 to 33 or 35.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a first cell, a cell switch command associated with a first cell switch operation; and
override the cell switch command based on a cell switch preemption capability of the UE.

2. The apparatus of claim 1, wherein to override the cell switch command based on the cell switch preemption capability of the UE, the at least one processor is configured to one or more of:
refrain from performing the first cell switch operation associated with the cell switch command;
override one or more values for one or more parameters associated with the cell switch command; or
perform a second cell switch operation to a UE-selected target cell that is different from a first target cell indicated in the cell switch command, wherein the second cell switch operation is not indicated in the cell switch command.

3. The apparatus of claim 2, wherein the cell switch command is associated with one of:
a lower-layer triggered mobility (LTM);
a conditional LTM;
a layer 3 (L3) handover; or
a conditional L3 handover, and wherein to override the cell switch command based on the cell switch preemption capability of the UE, the at least one processor is configured to:
refrain from performing the first cell switch operation associated with the L3 handover and performing the second cell switch operation associated with the conditional LTM; or
refrain from performing the first cell switch operation associated with the LTM and performing the second cell switch operation associated with one of the conditional LTM or the conditional L3 handover.

4. The apparatus of claim 1, wherein the at least one processor is further configured to:
transmit, to the first cell, an indication of support for the cell switch preemption capability prior to reception of the cell switch command.

5. The apparatus of claim 4, wherein the at least one processor is further configured to:
receive, from the first cell, an additional indication that the cell switch preemption capability is one of allowed or disallowed by the first cell.

6. The apparatus of claim 5, wherein the additional indication is included in a radio resource control (RRC) message and applies to one of:
lower-layer triggered mobility (LTM) for the UE; or
one or more groups of one or more LTM candidate cells.

7. The apparatus of claim 5, wherein the additional indication is included in one of downlink control information (DCI), a medium access control (MAC) control element (CE) (MAC-CE), or a lower-layer triggered mobility (LTM) cell switch command.

8. The apparatus of claim 1, wherein the at least one processor is further configured to:
transmit, to one of the first cell or a target cell for a non-indicated cell switch, an indication relating to the override of the cell switch command, wherein the indication relates to one or more of a reason for the override of the cell switch command, an action taken instead of performing the first cell switch operation, a candidate target cell, a candidate target group of cells, metrics for listed candidate cells, a metric for an indicated target cell in the cell switch command.

9. The apparatus of claim 1, wherein the at least one processor is further configured to:
obtain mobility-related information, wherein the override of the cell switch command is based on the mobility-related information and the mobility-related information comprises one or more of a channel measurement history associated with one or more cells, a cell search history, a cell switch history, one or more key performance indicators associated with the cell search history, dual connection statistics, an internal condition of the UE, or one or more artificial intelligence (AI)/machine learning (ML) predictions.

10. The apparatus of claim 1, wherein the at least one processor is further configured to:
obtain mobility-related information, wherein the mobility-related information comprises one or more of a channel measurement history associated with one or more cells, a cell search history, a cell switch history, one or more key performance indicators associated with the cell search history, dual connection statistics, an internal condition of the UE, or one or more artificial intelligence (AI)/machine learning (ML) predictions; and
transmit, to the first cell and based on the mobility-related information, one or more of assistance information or a mobility-related request.

11. The apparatus of claim 10, wherein one or more of the assistance information or the mobility-related request comprises one or more of:
a first indication of a first set of candidate target cells for a lower-layer triggered mobility (LTM) operation,
a second indication of a second set of candidate target cells for a conditional LTM operation,
a first request to update a current set of candidate target cells for the cell switch command,
a second request to activate a transmission configuration indicator for a first candidate target cell,
a third request for an early uplink random access channel synchronization, or
a fourth request to initiate a LTM operation.

12. The apparatus of claim 10, wherein one or more of the assistance information or the mobility-related request is associated with an indication of a reason for transmitting one or more of the assistance information or the mobility-related request, wherein the reason relates to one or more of:
a first quality of a first signal from the first cell being less than a first threshold quality,
a second quality of a second signal from at least one candidate target cell being greater than a second threshold quality,
a first identification of a first set of cells that are better candidate target cells than at least a first candidate target cell in a current set of candidate target cells,
a second identification of a second set of candidate target cells in the current set of candidate target cells that do not meet one or more criteria for being included in the current set of candidate target cells,
a third identification of one or more transmission configuration indicators (TCIs) that are better TCIs than one or more current TCIs, or
a fourth identification of one or more activated TCIs that are associated with a third quality that is below a third threshold quality.

13. The apparatus of claim 10, wherein one or more of the assistance information or the mobility-related request is associated with an indication of an action to be performed by the UE if the UE fails to receive a response to one or more of the assistance information or the mobility-related request within a response window, wherein the UE is configured with a conditional LTM configuration associated with a set of candidate target cells and a corresponding set of beams, and wherein the action comprises one or more of:
a first conditional LTM cell switch operation based on the conditional LTM configuration towards a first candidate target cell in the set of candidate target cells and a corresponding beam selected by the UE that is not a first target cell indicated in the cell switch command, or
a TCI state activation with a second candidate target cell in the set of candidate target cells and a beam selected by the UE.

14. The apparatus of claim 10, wherein the at least one processor is further configured to:
receive, from the first cell, an indication of a response of the first cell to one or more of the assistance information or the mobility-related request, wherein the response comprises one or more of an acceptance of one or more of the assistance information or the mobility-related request, a rejection of one or more of the assistance information or the mobility-related request, or an alternative to one or more of the assistance information or the mobility-related request.

15. The apparatus of claim 14, wherein to receive the indication, the at least one processor is configured to one of:
receive one of downlink control information (DCI) or a medium access control (MAC) control element (CE) (MAC-CE) indicating the response of the first cell; or
fail to receive an explicit indication during a response window, wherein failure to receive the explicit indication indicates the acceptance of one or more of the assistance information or the mobility-related request.

16. The apparatus of claim 15, wherein the failure to receive the explicit indication further indicates for the UE to autonomously determine whether to take an action associated with one or more of the assistance information or the mobility-related request, wherein the at least one processor is further configured to:
perform the action associated with one or more of the assistance information or the mobility-related request; and
transmit an additional indication of the action performed by the UE.

17. The apparatus of claim 10, wherein the at least one processor is further configured to one or more of:
transmit, to the first cell, an indication of whether the UE supports a transmission of at least one of the assistance information or the mobility-related request; or
transmit, to the first cell, an additional indication of one or more functionalities associated with at least one of the assistance information or the mobility-related request supported by the UE.

18. The apparatus of claim 1, wherein the at least one processor is further configured to:
transmit, to the first cell, an indication of the override of the cell switch command based on the cell switch preemption capability of the UE.

19. A method of wireless communication at a user equipment (UE), comprising:
receiving, from a first cell, a cell switch command associated with a first cell switch operation; and
overriding the cell switch command based on a cell switch preemption capability of the UE.

20. An apparatus for wireless communication at a network device, comprising:
at least one memory; and
at least one processor coupled to the at least one memory and, based at least in part on information stored in the at least one memory, the at least one processor is configured to:
transmit, to a user equipment (UE), a cell switch command associated with a first cell switch operation; and
receive, from the UE, an indication of an override of the cell switch command based on a cell switch preemption capability of the UE.
